(19) United States
(12) Patent Application Publication
(10) Pub. No.: US 2026/0270354 A1
(43) Pub. Date: Sep. 10, 2026

(54) MEDIUM PROCESSING APPARATUS AND IMAGE FORMING SYSTEM INCORPORATING SAME

(71) Applicant: Takuya MORINAGA, Tokyo (JP)

(72) Inventor: Takuya MORINAGA, Tokyo (JP)

(73) Assignee: ETRIA CO., LTD., Yokohama-shi (JP)

(21) Appl. No.: 19/549,588

(22) Filed: Feb. 25, 2026

(30) Foreign Application Priority Data
Mar. 10, 2025 (JP) 2025-037540

(51) Int. Cl. H04N 1/00

(52) U.S. Cl. CPC H04N 1/00631; H04N 1/00427; H04N 1/00602; H04N 1/00615; H04N 1/00639; H04N 1/00702; H04N 1/00742; H04N 1/00774

(57) ABSTRACT

A medium processing apparatus includes a medium stacker, an end portion processor, and circuitry. The medium stacker stacks media including a medium on which an image is formed by an image forming process. The end portion processor processes end portions of the media stacked on the medium stacker. The circuitry is to estimate a displacement amount of positional displacement between the end portions of the media stacked on the medium stacker, based on at least of attribute information of the media or print information to set the image forming process, and control at least one of the medium stacker or the end portion processor to reduce the displacement amount according to combinations of the attribute information and the print information, based on the displacement amount estimated.

### CROSS-REFERENCE TO RELATED APPLICATION

This patent application is based on and claims priority pursuant to 35 U.S.C. § 119(a) to Japanese Patent Application No. 2025-037540, filed on Mar. 10, 2025, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Related Art

Sheet processing apparatuses are known to perform, for example, an alignment process, and a folding process on a sheet-like medium (sheet). In addition, image forming apparatuses are known to have a function corresponding to such a sheet processing apparatus and a function of forming an image on a sheet. Image forming system are known that include such a sheet processing apparatus and an image forming apparatus.

A sheet processing apparatus is disclosed to have a control method for ejecting a bundle of media into a stacking tray based on the weight of the bundle of media superposed on a pre-stack tray so as to enhance alignment of the bundle of media ejected into the stacking tray in a medium processing apparatus.

In the technique described in the sheet processing apparatus, when a succeeding medium to be subsequently conveyed is superposed on a preceding medium standing by in the pre-stack tray, the leading end portion of the succeeding medium is conveyed prior to the leading end portion of the preceding medium. As a result, the trailing end of the succeeding medium is conveyed onto a staple tray in a state of being displaced to the upstream side of the trailing end of the preceding medium, and is contacted against a contact member provided on the downstream side by a return roller. Accordingly, the trailing end of the succeeding medium and the trailing end of the preceding medium are aligned. However, the above-described technique is disadvantageous in that when sticking occurs between the preceding medium and the succeeding medium included in the bundle of media, alignment between the trailing end of the succeeding medium and the trailing end of the preceding medium becomes insufficient on the staple tray, and thus, binding displacement may occur or a medium may be missing in binding due to positional displacement between the trailing end of the succeeding medium and the trailing end of the preceding medium.

### SUMMARY

Embodiments of the present disclosure described herein provide a novel medium processing apparatus includes a medium stacker, an end portion processing unit, and circuitry. The medium stacker stacks media including a medium on which an image is formed by an image forming process. The end portion processor processes end portions of the media stacked on the medium stacker. The circuitry is to estimate a displacement amount of positional displacement between the end portions of the media stacked on the medium stacker, based on at least of attribute information of the media or print information to set the image forming process, and control at least one of the medium stacker or the end portion processor to reduce the displacement amount according to combinations of the attribute information and the print information, based on the displacement amount estimated.

Further, embodiments of the present disclosure described herein provide an image forming system including an image forming apparatus that forms an image on a medium, and the above-described medium processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming system according to an embodiment of the present disclosure;

FIG. 2 is a schematic diagram illustrating a medium processing apparatus according to an embodiment of the present disclosure;

FIG. 3 is a block diagram illustrating a control configuration of the image forming system according to the embodiment of the present disclosure;

FIGS. 4A, 4B and 4C are diagrams illustrating steps of a pre-stack process according to the embodiment;

FIGS. 5A, 5B and 5C are diagrams illustrating steps of the pre-stack process according to the embodiment;

FIGS. 6A, 6B and 6C are diagrams illustrating steps of the pre-stack process according to the embodiment;

FIGS. 7A and 7B are explanatory diagrams of a medium sticking defect in the medium processing apparatus according to the embodiment;

FIG. 8 is a diagram illustrating an embodiment of a trained model that can be installed on the medium processing apparatus;

FIG. 9 including FIGS. 9A and 9B is a table illustrating exemplary training data to be used for generating the trained model;

FIG. 10 is a diagram illustrating an outline of a process in which the amount of positional displacement is inferred by the trained model;

FIG. 11 is a flowchart illustrating an exemplary control process that can be executed by the medium processing apparatus;

FIGS. 12A and 12B are the first and second halves of a flowchart illustrating an exemplary control process that can be executed by the medium processing apparatus;

FIG. 13 is a flowchart illustrating an exemplary control process that can be executed by the medium processing apparatus;

FIGS. 14A and 14B are the first and second halves of a flowchart illustrating an exemplary control process that can be executed by the medium processing apparatus;

FIGS. 15A and 15B are explanatory diagrams of return roller control that can be executed by the medium processing apparatus;

FIG. 16 is a flowchart illustrating an exemplary control process that can be executed by the medium processing apparatus;

FIGS. 17A and 17B are the first and second halves of a flowchart illustrating an exemplary control process that can be executed by the medium processing apparatus;

FIG. 18 is a flowchart illustrating an exemplary control process that can be executed by the medium processing apparatus;

FIGS. 19A and 19B are the first and second halves of a flowchart illustrating an exemplary control process that can be executed by the medium processing apparatus;

FIGS. 20A, 20B and 20C are diagrams illustrating a method for acquiring medium information and image forming information that can be executed in the image forming system;

FIGS. 21A, 21B and 21C are diagrams illustrating a method for acquiring medium information that can be executed in the image forming system;

FIG. 22 is a diagram illustrating a method for specifying a control process that can be executed by the medium processing apparatus;

FIG. 23 is a diagram illustrating an exemplary case of installing the trained model on the image forming system; and

FIG. 24 is a diagram illustrating another exemplary case of installing the trained model on the image forming system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### Embodiment of Image Forming System

A description is given of a configuration of an image forming system according to an embodiment of the present disclosure.

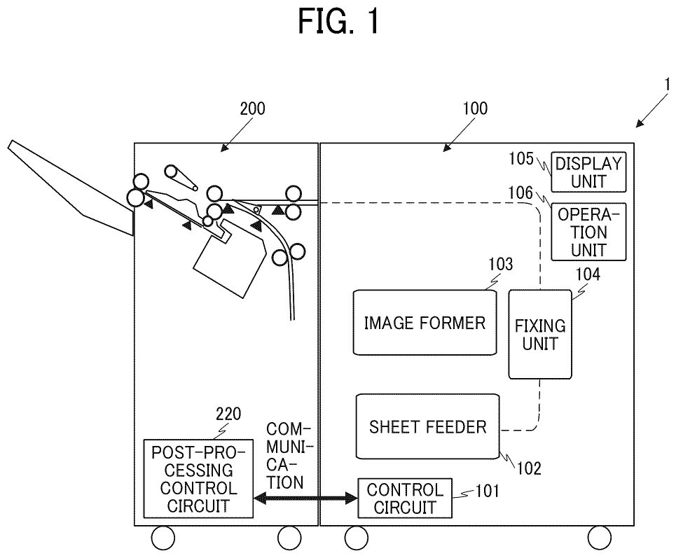

FIG. 1 is a schematic diagram illustrating an image forming system 1.

The image forming system 1 includes an image forming apparatus 100 and a post-processing apparatus 200 coupled to each other. The post-processing apparatus 200 serves as a medium processing apparatus according to an embodiment of the present disclosure.

The image forming apparatus 100 has a known configuration, and has a function of forming an image on a sheet-like medium. The image forming apparatus 100 also has a function of acquiring medium information when executing a process of forming an image. The medium information is information indicating attributes of the sheet-like medium such as the size, quality, and thickness of the sheet-like medium. In addition, the image forming apparatus 100 also has a function of acquiring image formation setting information including information related to an image to be formed on the sheet-like medium, information for setting operation of a mechanism to be used to form the image, and the like. The image forming apparatus 100 also has a function of communicating the medium information and the image formation setting information to the post-processing apparatus 200. The post-processing apparatus 200 is disposed on the downstream side of the image forming apparatus 100, and performs post-processing on a sheet-like medium on which an image has been formed.

Examples of an image forming method to be adopted by an image forming unit that can be installed in the image forming apparatus 100 include a process using a known electrophotographic method and an image forming process using an inkjet method. In the present disclosure, any image forming method is applicable, and details are not limited as long as the process is performed on sheet-like media. The following embodiment will be described on the premise of an electrophotographic method. In the following embodiment, a “sheet” will be described as an example of the sheet-like medium. However, an object to be processed in the present embodiment is not limited to a “sheet”, and just needs to be a sheet-like medium that can be processed by the post-processing apparatus 200 as described below.

The image forming apparatus 100 includes, for example, a display unit 105, an operation unit 106, a sheet feeder 102, an image former 103, a fixing unit 104, and an image formation control circuit 101 as constituent elements for implementing the functions exemplified above. The display unit 105 is a constituent element that implements a function of notifying a user who uses the image forming system 1 of states and operation details of various apparatuses (the image forming apparatus 100, the post-processing apparatus 200, and devices including functional configurations thereof). The operation unit 106 is a constituent element that implements a function for the user to perform, for example, operation of setting a mode, and the number of copies. The sheet feeder 102 is a constituent element that implements a function of stocking sheets, separating the sheets one by one, and conveying the sheets toward the image former 103 and the fixing unit 104.

The image former 103 is a constituent element that implements a function of forming a latent image on a photoconductor and transferring the image onto a sheet. The fixing unit 104 is a constituent element that implements a function of fixing the image transferred onto the sheet.

The image formation control circuit 101 is a constituent element for controlling operation of the entire image forming apparatus 100 including each of the listed constituent elements.

As described below, the post-processing apparatus 200 has a function of being stacked with sheets conveyed from the image forming apparatus 100, aligning end portions of the sheets to form a sheet bundle Ps, and performing a binding process on a part of an end portion of the sheet bundle Ps. The post-processing apparatus 200 performs a sheet binding process on the basis of settings specified by the image formation setting information or the medium information notified from the image formation control circuit 101.

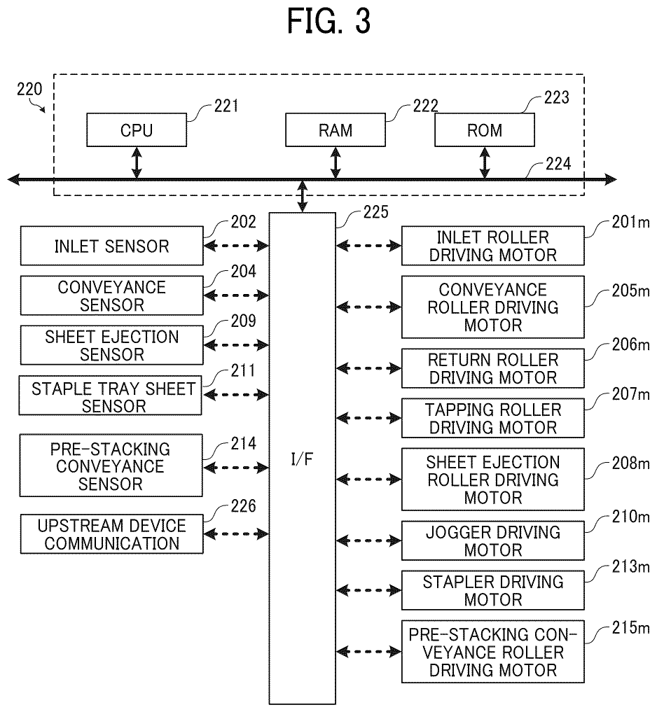

The post-processing apparatus 200 includes a post-processing control circuit 220. The post-processing control circuit 220 is a constituent element that implements control of rollers at the time of performing a binding process and implements communication with the image formation control circuit 101 that controls the image forming apparatus 100. Details of the post-processing control circuit 220 will be described with reference to FIG. 3.

### Embodiment of Medium Processing Apparatus

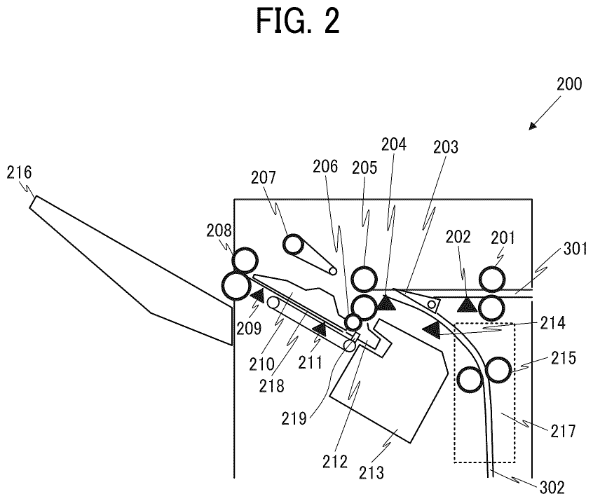

The post-processing apparatus 200 serving as the medium processing apparatus according to the embodiment of the present disclosure will be described with reference to FIG. 2.

FIG. 2 is a schematic configuration diagram of the post-processing apparatus 200 having a pre-stacking function.

The post-processing apparatus 200 has a sheet conveyance path 301. A sheet received from the image forming apparatus 100 is conveyed through the sheet conveyance path 301 by, for example, an inlet roller pair 201, a conveyance roller pair 205, and a sheet ejection roller pair 208. In addition, the post-processing apparatus 200 has a pre-stacking conveyance path 302 branching off from the sheet conveyance path 301. A sheet received from the image forming apparatus 100 is conveyed through the pre-stacking conveyance path 302 by the conveyance roller pair 205 and the pre-stacking conveyance roller pair 215. In particular, the conveyance roller pair 205 serving as a first conveyor, the sheet ejection roller pair 208, and the pre-stacking conveyance roller pair 215 serving as a second conveyor can be driven in normal rotation and reverse rotation for a pre-stack process and a process of contacting a contact guide plate 212.

The pre-stacking conveyance path 302 including a pre-stacking conveyance sensor 214 and a pre-stacking conveyance roller pair 215 is included in a pre-stacking portion 217 for pre-stacking sheets received from the image forming apparatus 100. Positions of the leading end and the trailing end of a sheet in a sheet conveyance direction are detected by an inlet sensor 202 and a conveyance sensor 204. The conveyance roller pair 205 and the pre-stacking conveyance roller pair 215 are driven in reverse rotation at the timing when the trailing end of the sheet passes through the conveyance sensor 204. In addition, a branch member 203 is switched to a position that allows the sheet to be guided to the pre-stacking conveyance path 302. Then, the sheet is conveyed to the pre-stacking portion 217 by the conveyance roller pair 205 and the pre-stacking conveyance roller pair 215 driven in reverse rotation. In other words, the term “pre-stack process” refers to a process of reversing (switching back) the conveyance direction of a sheet being conveyed on the sheet conveyance path 301 toward a staple tray 218 by the inlet roller pair 201 as a medium conveyor by the reverse-rotation driving of the conveyance roller pair 205 and the pre-stacking conveyance roller pair 215, and conveying the sheet to the pre-stacking portion 217.

In a case where a stapling operation, which is an example of a binding process to be performed on the end portion of the sheet bundle Ps including multiple bundled sheets, is performed, sheets delivered from the conveyance roller pair 205 to the sheet ejection roller pair 208 are dropped onto the staple tray 218 including the contact guide plate 212 by a tapping roller 207. Then, sheets placed on the staple tray 218 are conveyed toward the contact guide plate 212 by the sheet ejection roller pair 208 and a return roller 206. As a result, leading end portions of the sheets in the conveyance direction contact the contact guide plate 212. Through this series of actions, an alignment process is performed in which end portions of the sheets placed on the staple tray 218 are aligned with an end portion of a sheet conveyed later in a sub-scanning direction (conveyance direction). After rollers of the sheet ejection roller pair 208 are separated from each other, the sheets contacting the contact guide plate 212 are subjected to a alignment process in which end portions are aligned in a main scanning direction (sheet width direction) by a jogger 210. Then, when the alignment process of sheets is completed in the main scanning direction and the sub-scanning direction, a stapler 213 serving as a stapling unit performs a stapling operation on multiple sheets placed on the staple tray 218 to form a sheet bundle Ps. Then, the sheet bundle Ps placed on the staple tray 218 is ejected into a sheet ejection tray 216 by an ejection member 219 and the sheet ejection roller pair 208 cooperating with each other. This ejection operation is referred to as an “ejection process”.

A “medium stacker” includes the staple tray 218, the conveyance roller pair 205 serving as the first conveyor, and the pre-stacking conveyance roller pair 215 serving as the second conveyor.

An “end portion processing unit” includes the contact guide plate 212, the return roller 206, and the stapler 213.

### Control Configuration of Medium Processing Apparatus

A control configuration of the post-processing apparatus 200 will be described with reference to FIG. 3.

FIG. 3 is a hardware configuration diagram of the post-processing control circuit 220 as an example of the control configuration of the post-processing apparatus 200.

As illustrated in FIG. 3, in the post-processing control circuit 220, a central processing unit (CPU) 221, a random access memory (RAM) 222, a read only memory (ROM) 223, and an interface (I/F) 225 for connecting these constituent elements to sensors and motors are connected via a common bus 224.

The CPU 221 is an arithmetic unit, and controls the entire operation of the post-processing apparatus 200. The RAM 222 is a volatile storage medium that allows data to be read and written at high speed. The CPU 221 uses the RAM 222 as a working area for data processing. The ROM 223 is a read-only nonvolatile storage medium that stores programs such as firmware.

The post-processing apparatus 200 processes, for example, a control program stored in the ROM 223 and an information processing program (application program) loaded from a predetermined storage medium into the RAM 222, by an arithmetic function of the CPU 221. Such processing configures a software controller including various functional modules of the post-processing apparatus 200. The software controller thus configured cooperates with hardware resources of the post-processing apparatus 200 to construct functional blocks that implement functions of the post-processing apparatus 200. In other words, the CPU 221, the RAM 222, the ROM 223, and the I/F 225 form the post-processing control circuit 220 (control unit) that controls operation of the post-processing apparatus 200.

Through the I/F 225, the post-processing control circuit 220 controls operation of an inlet roller driving motor 201m, a conveyance roller driving motor 205m, a return roller driving motor 206m, a tapping roller driving motor 207m, a sheet ejection roller driving motor 208m, a jogger driving motor 210m, a staple driving motor 213m, and a pre-stacking conveyance roller driving motor 215m. The inlet roller driving motor 201m drives the inlet roller pair 201. The conveyance roller driving motor 205m drives the conveyance roller pair 205. The return roller driving motor 206m drives the return roller 206. The tapping roller driving motor 207m 201 drives the tapping roller 207. The sheet ejection roller driving motor 208m drives the sheet ejection roller pair 208. The jogger driving motor 210m drives the jogger 210. The staple driving motor 213m drives the stapler 213. The pre-stacking conveyance roller driving motor 215m drives the pre-stacking conveyance roller pair 215. The post-processing control circuit 220 acquires results of detection by the inlet sensor 202, the conveyance sensor 204, a sheet ejection sensor 209, a staple tray sheet sensor 211, and the pre-stacking conveyance sensor 214.

An upstream device communication 226 is an interface for communicating with the image formation control circuit 101 included in the image forming apparatus 100 illustrated in FIG. 1, and performs data communication regarding data for control. Furthermore, the sensors and the motors described in FIG. 2 are coupled to the post-processing control circuit 220 via the I/F 225 and used for control. In other words, the upstream device communication 226 is a communication unit, and also serves as a notification unit.

The CPU 221 controls the post-processing apparatus 200 by executing a computer-readable program stored in the ROM 223. The ROM 223 stores, for example, data and programs to be executed by the CPU 221. The RAM 222 temporarily stores, for example, data when the CPU 221 executes a program.

### Flow of Pre-Stack Process

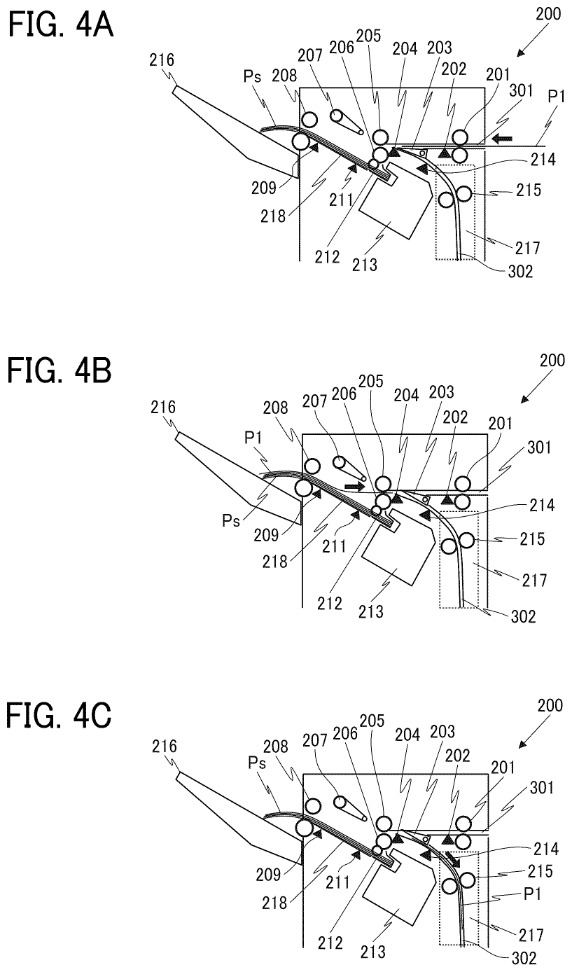

The flow of the pre-stack process to be executed in the post-processing apparatus 200 will be described with reference to FIGS. 4A to 6C.

FIGS. 4A, 4B and 4C are diagrams describing steps of the pre-stack process according to the present embodiment.

Specifically, FIG. 4A illustrates a state in which, during execution of a binding related process on the sheet bundle Ps as a bundle of sheet-like media already placed on the staple tray 218 (operation of alignment of the sheet bundle Ps in the width direction by the jogger 210, operation of contact of the end portion of the sheet bundle Ps against the contact guide plate 212, and binding operation of the sheet bundle Ps by the stapler 213), a succeeding sheet P2 (referred to as a “succeeding sheet P2”), which is a sheet to be subsequently conveyed, has been conveyed subsequent to a pre-stack sheet P1 (referred to as a “pre-stack sheet P1”), which is a preceding sheet already conveyed toward the staple tray 218, from the image forming apparatus 100.

The pre-stack sheet P1 and the succeeding sheet P2 are among multiple sheets to be included in a subsequent sheet bundle Ps. In this case, since the binding related process of the sheet bundle Ps is, for example, being executed in the staple tray 218, and the process of aligning the sheet bundle Ps stacked on the staple tray 218 have not been completed. Thus, the pre-stack sheet P1 cannot be conveyed to the staple tray 218 and newly stacked on the staple tray 218. The branch member 203 is rotated by, for example, a spring with a spring constant that allows the branch member 203 to be pushed open by stiffness of the pre-stack sheet P1, so as not to hinder conveyance of the pre-stack sheet P1.

FIGS. 4B and 4C illustrate a process of conveying the pre-stack sheet P1 to the pre-stacking portion 217.

The post-processing control circuit 220 performs control such that the direction of the driving of the conveyance roller pair 205 is reversed at a timing when the trailing end of the pre-stack sheet P1 passes through the conveyance sensor 204. Thus, the pre-stack sheet P1 is conveyed to the pre-stacking portion 217 including the pre-stacking conveyance sensor 214 and the pre-stacking conveyance roller pair 215. As a result, even during the execution of the binding related process of the sheet bundle Ps in the staple tray 218, the post-processing apparatus 200 can receive the pre-stack sheet P1 from the image forming apparatus 100.

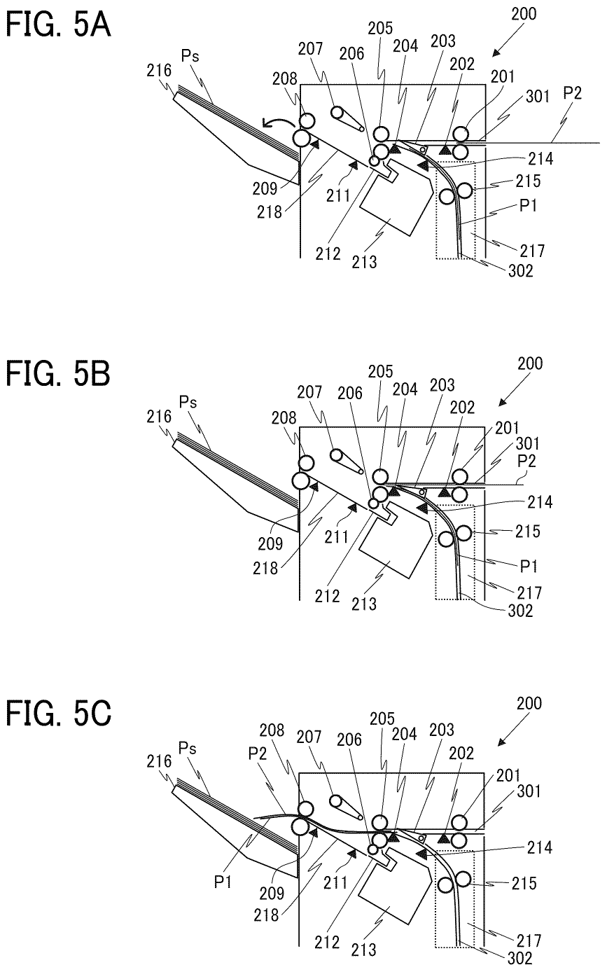

FIGS. 5A, 5B and 5C are diagrams describing steps of the pre-stack process according to the present embodiment.

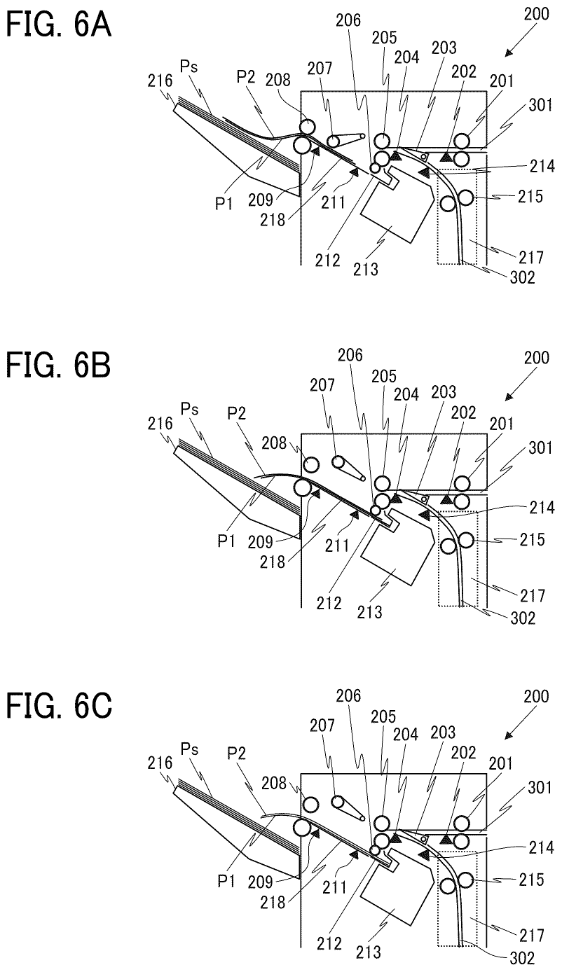

FIGS. 6A, 6B and 6C are diagrams describing steps of the pre-stack process according to the present embodiment.

Specifically, FIGS. 5A, 5B and 5C illustrate a situation in which the stapling operation is executed on the sheet bundle Ps in the staple tray 218, and the bound sheet bundle Ps is ejected into the sheet ejection tray 216, in a state in which the pre-stack sheet P1 is pre-stacked in the pre-stacking portion 217.

FIG. 5A illustrates a state in which the post-processing apparatus 200 receives the succeeding sheet P2 conveyed subsequently to the pre-stack sheet P1.

FIGS. 5B, 5C, 6A, 6B, and 6C illustrate a state in which the pre-stack sheet P1 having been pre-stacked and the succeeding sheet P2 subsequently received are conveyed to the staple tray 218.

In a case where the pre-stack sheet P1 is equal in size to the succeeding sheet P2, conveyance timing of the pre-stack sheet P1 and the succeeding sheet P2 is controlled such that the leading end of the succeeding sheet P2 slightly precedes the pre-stack sheet P1. The control of the conveyance timing is performed as follows. The distance from the inlet sensor 202 to the nip position of the conveyance roller pair 205 is grasped from the amount of driving of the inlet roller driving motor 201m that drives the inlet roller pair 201. When the leading end of the succeeding sheet P2 passes through the inlet sensor 202, the inlet sensor 202 notifies the post-processing control circuit 220 of a passage signal. An amount by which the succeeding sheet P2 has been conveyed since the timing of notification of the passage signal is monitored. Then, it is possible to implement the control of the conveyance timing by driving the pre-stacking conveyance roller pair 215 at the timing when the leading end of the succeeding sheet P2 precedes and starting conveyance of the pre-stack sheet P1.

The pre-stack sheet P1 and the succeeding sheet P2 are dropped onto the staple tray 218 by the tapping roller 207 after sheet trailing ends pass through the conveyance roller pair 205, and are moved by the sheet ejection roller pair 208 and the return rollers 206 in a direction in which the pre-stack sheet P1 and the succeeding sheet P2 contact the contact guide plate 212.

As described above, when the pre-stack sheet P1 and the succeeding sheet P2 are stacked, the succeeding sheet P2 is conveyed such that the leading end portion of the succeeding sheet P2 precedes the pre-stack sheet P1. Therefore, the trailing end of the pre-stack sheet P1 comes into contact with the contact guide plate 212 earlier. Thereafter, the succeeding sheet P2 moves in such a way as to slide on the pre-stack sheet P1 by the return roller 206, and also comes into contact with the contact guide plate 212. Thus, the trailing ends of the pre-stack sheet P1 and the succeeding sheet P2 can be aligned.

As described above, by using the pre-stacking function, the post-processing apparatus 200 can receive the pre-stack sheet P1 and the succeeding sheet P2 to be included in the subsequent sheet bundle Ps even during the binding related process of the sheet bundle Ps already placed on the staple tray 218. It is thus possible to avoid a decrease in productivity due to the stapling operating time for the sheet bundle Ps.

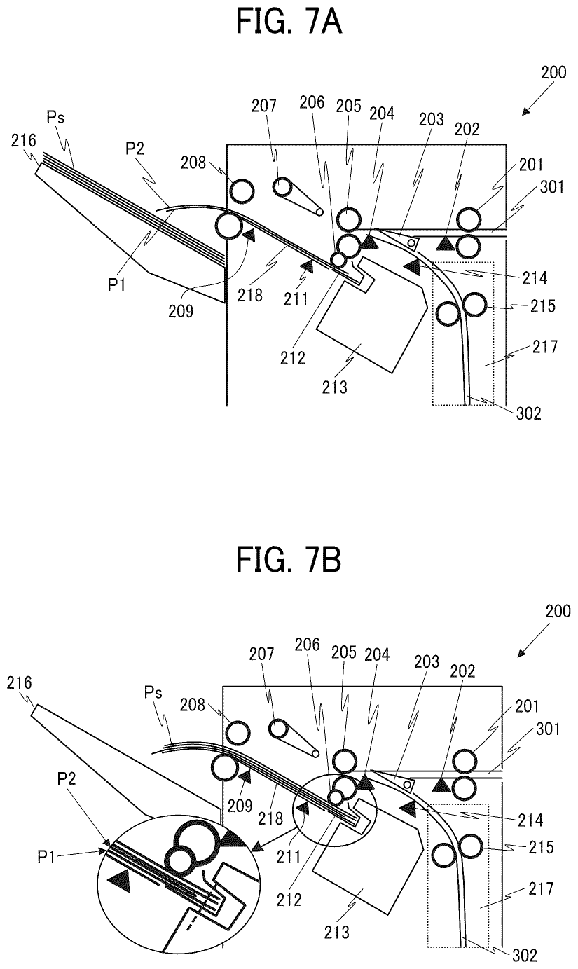

FIGS. 7A and 7B illustrate a defect due to sticking of multiple sheets superposed in the pre-stack process.

FIG. 7A is the same diagram as FIG. 6B, and illustrates operation of contacting the pre-stack sheet P1 and the succeeding sheet P2 which have been pre-stacked, against the contact guide plate 212.

When the pre-stack sheet P1 and the succeeding sheet P2 which have been pre-stacked are contacted to the contact guide plate 212, the end portions (trailing ends) of sheets in the sheet bundle Ps can be aligned as illustrated in FIG. 6C in a case where the succeeding sheet P2 can move in such a way as to slide on the pre-stack sheet P1.

However, the pre-stack sheet P1 and the succeeding sheet P2 are stacked at the timing of FIG. 5B and then conveyed to the position illustrated in FIG. 6B while remaining stacked. In this case, in order to align the trailing ends of the pre-stack sheet P1 and the succeeding sheet P2 as illustrated in FIG. 6C, the return roller 206 needs to convey the pre-stack sheet P1 and the succeeding sheet P2 with a force exceeding the static friction coefficient of the pre-stack sheet P1 and the succeeding sheet P2.

Here, it is conceivable that a force with which a high-temperature sheet that has just been ejected from the image forming apparatus 100 is stuck by toner and a force with which a sheet greatly affected by static electricity due to properties such as a paper type is stuck may be larger than the conveyance force of the return roller 206. In this case, the succeeding sheet P2 cannot be conveyed to the contact guide plate 212 depending on the conveyance force of the return roller 206. Thus, the binding process of the sheet bundle Ps is executed in a state where the trailing ends of the pre-stack sheet P1 and the succeeding sheet P2 are not aligned, as illustrated in FIG. 7B. As a result, since a position indicated by a broken line in the drawing enlarged view of FIG. 7B corresponds to a binding position, binding displacement may occur and a medium may become missing in binding due to positional displacement in the sheet bundle Ps.

### Trained Model Generation by Machine Learning

A description will be given of a step of generating a trained model by machine learning applicable to the medium processing apparatus according to the present disclosure.

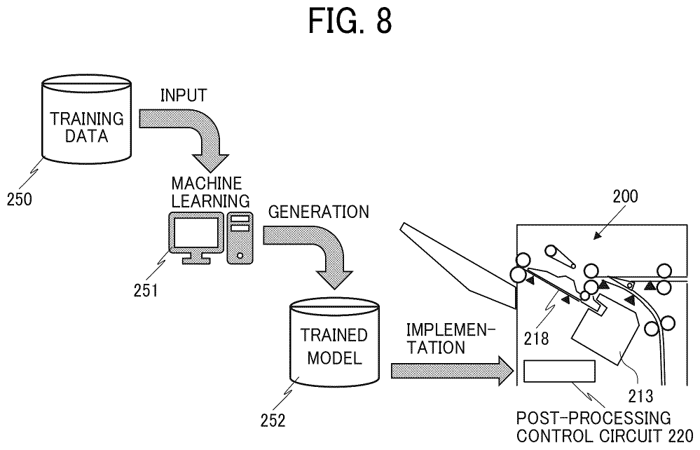

FIG. 8 is a diagram describing a trained model to be installed in the post-processing apparatus 200 according to the present embodiment.

A trained model 252 generated by machine learning can be implemented in the control program written in the post-processing control circuit 220 of the post-processing apparatus 200 according to the present embodiment. The trained model 252 corresponds to a functional module generated based on, for example, analysis of feature amounts of training data 250 by use of a machine learning process. The training data 250 are generated, by an external personal computer (PC) 251 that allows generation of the trained model 252 or cloud service, from various data obtained by evaluation at the time of designing the image forming system 1, the image forming apparatus 100, and the post-processing apparatus 200. The trained model 252 generated by machine learning is a kind of calculation algorithm, and is implemented as a module as a part of a control program. A detailed description will be given below of how to use the trained model 252 implemented as a control program.

By using the trained model 252 in a control program that can be executed in the post-processing control circuit 220, it is possible to predict (estimate) the amount of positional displacement between the end portions of multiple sheets stacked on the staple tray 218 (simply referred to as the “amount of positional displacement”) even in the case of combinations of medium information and image formation setting information that are not evaluated at the time of design. Then, in the control program that can be executed by the post-processing control circuit 220, reducing operation for reducing positional displacement between the end portions of the multiple sheets on the staple tray 218 is controlled on the basis of prediction (estimation) of the amount of positional displacement. As a result, the degree of alignment of positions of the end portions of the multiple sheets stacked on the staple tray 218 is enhanced. It is thus possible to prevent “binding displacement” and prevent a medium from “missing in binding”. Here, the term “end portions of the multiple stacked sheets” refers to the leading end portion of the sheet bundle Ps in a direction in which the sheet bundle Ps is moved on the staple tray 218 toward the contact guide plate 212.

In other words, the trained model 252 is used for the control program to be executed in the post-processing control circuit 220. Thus, the control program includes a positional displacement amount estimation unit.

For example, when the stapling operation is executed on a sheet corresponding to a sheet that has not been evaluated in advance as a combination of medium information and image formation setting information, binding process information including information on the setting of the stapling operation is also input to the trained model 252 as an estimation unit. An “appropriate amount of positional displacement” for preventing binding displacement and preventing a medium from missing in binding is estimated from the trained model 252. The control program that can be executed in the post-processing control circuit 220 allows control of conveyance of sheets and control of the pre-stack process to be performed on the basis of the estimated amount of positional displacement so as to cancel the amount of positional displacement. In other words, it is possible to prevent binding displacement and prevent a medium from missing in binding by executing a conveyance process of conveying a sheet to the staple tray 218 and the alignment process to be performed on the staple tray 218 on the basis of the estimated amount of positional displacement.

### Example of Training Data

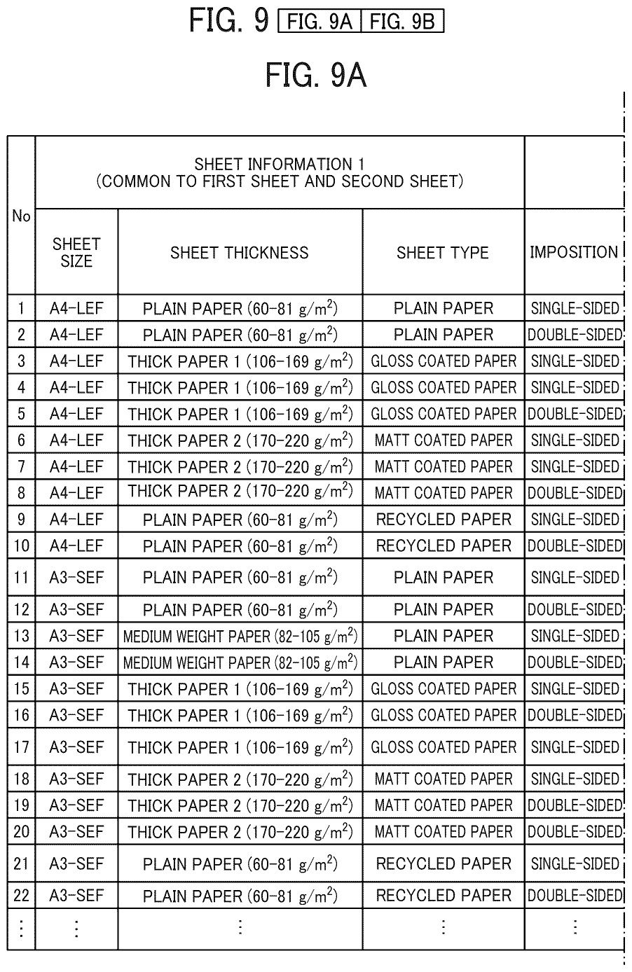

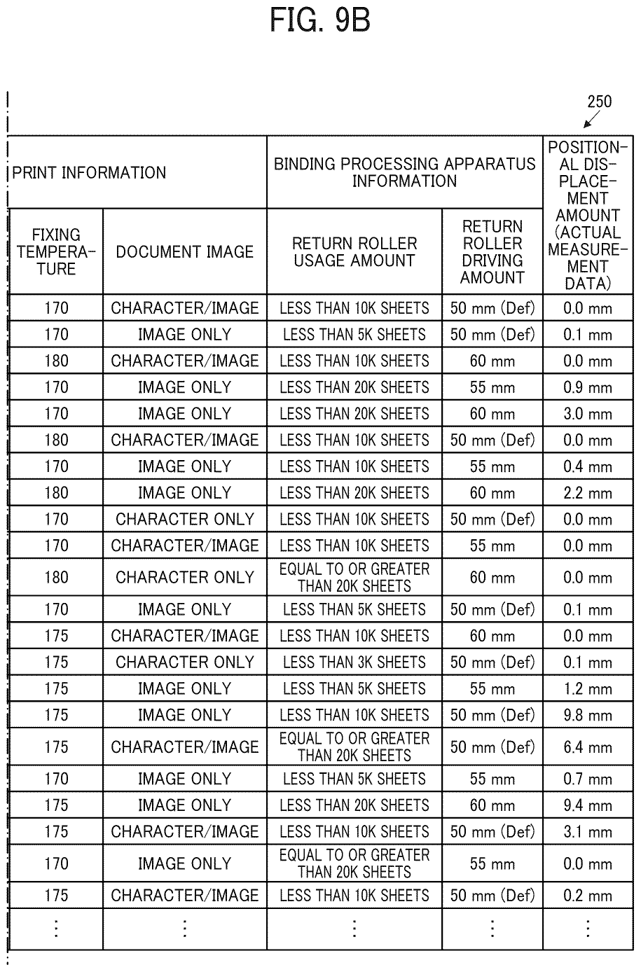

FIG. 9 including FIGS. 9A and 9B is a table illustrating the training data 250 to be used for generating the trained model 252.

In the present embodiment, the medium information on sheets to be superposed by the pre-stack process, the image formation setting information, and apparatus information on the post-processing apparatus 200 are used as input data. The training data 250 are generated by use of the input data together with data obtained by actual measurement of the amount of positional displacement of sheets to be predicted in an inference step. Then, the training data 250 are analyzed by machine learning.

In the following description, the image formation setting information may be referred to as print information.

The medium information serving as the attribute information is information indicating attributes of a sheet, and corresponds to, for example, information including the size (sheet size), quality (sheet type), and thickness (sheet thickness) of the sheet. Furthermore, the image formation setting information corresponds to information regarding an image formed on a medium on which the image has been formed, and information for setting operation of a mechanism to be used to form the image.

In the training data 250 illustrated in FIGS. 9A and 9B of FIG. 9, data such as sheet size, sheet thickness, and sheet types are set as the medium information that affects the sticking of sheets. In a case where the sheet size is relatively large, a sticking area increases, and thus it is conceivable that the degree of sticking may increase.

In addition, since the influence of fixing temperature tends to remain depending on paper thickness, it is conceivable that the degree of stickiness may increase when the thickness of a sheet is large. In addition, since ease of sticking varies depending on properties of a coated paper surface, it is conceivable that the degree of stickiness may vary depending on paper types.

These data exemplify medium information that can be generally set in the image forming system 1.

A known unit for determining a paper brand from glossiness or smoothness may be used for the image forming apparatus 100 or the post-processing apparatus 200. Thus, data likely to affect stickiness between sheets, such as glossiness or smoothness, may be measured by a dedicated sensor and added to the training data 250 for use instead of other data.

Furthermore, data such as distinction between impositions, fixing temperature, and content of a document image are set as the print information. In the case of the imposition of “double-sided printing”, toners on sheets come in contact with each other. Thus, it is conceivable that the sheets are likely to stick to each other. When fixing temperature is high, it takes time to solidify toner. Thus, it is conceivable that sheets are likely to stick to each other. In addition, with regard to the content of the document image, an image uses more toner than character information. Thus, it is conceivable that the degree of stickiness may increase. The training data 250 using data for estimating the degree of stickiness between sheets, which may cause binding displacement, are formed on the assumption of the above.

The medium information and the print information are setting data to be held in the image forming apparatus 100. Therefore, the medium information and the print information are also easily used for a controlling process in the post-processing apparatus 200. Therefore, the amount of toner to be used for each print side, environmental temperature and humidity at the time of printing, for example, may be added to the training data 250 and used instead of other data.

Control information on the post-processing apparatus 200 such as a return roller usage amount and a return roller conveyance amount is set as binding process apparatus information. In setting the binding process apparatus information as the control information, the return roller usage amount is included in the binding process apparatus information. This is because conveyance force decreases due to abrasion of the surface of the return roller. In addition, when the binding process apparatus information is set, the return roller conveyance amount is included in the binding process apparatus information. This is because it is possible to increase the possibility that sheets can be conveyed to the contact guide plate 212, by setting a longer conveyance distance for driving the return roller 206 in the direction of the contact guide plate 212.

As long as the configuration of the post-processing apparatus 200 allows the return roller 206 to change the pressurizing force for pressurizing a sheet, the pressurizing force of the return roller 206 or other data may be added to the training data 250 and used instead.

In the training data 250 during the step of generating the trained model 252, it is to present output data desired to be received in the inference step, together with the medium information, the print information, and the binding process apparatus information described above. In the present embodiment, the amount of displacement of trailing ends of sheets at the time of completion of conveyance of the sheets stacked by the pre-stacking function to the contact guide plate 212 is added to the training data 250 and analyzed by machine learning.

As described above, in the post-processing apparatus 200 according to the present embodiment, the trained model 252 generated by a machine learning is applied to the estimation unit for estimating the amount of positional displacement. As a result, it is possible to estimate an appropriate amount of positional displacement even for combinations not evaluated at the time of design.

Furthermore, it is possible to more accurately calculate the estimated value of the amount of positional displacement by including the control information on the post-processing apparatus 200 in the training data 250.

In addition, in a case where there is a possibility of occurrence of binding displacement due to positional displacement caused by execution of pre-stacking, control is performed such that the pre-stack process is not executed even when a job interval (time for executing an image forming process and a stack process on a single sheet) is increased. In other words, it is possible to avoid binding displacement due to positional displacement caused by the pre-stack process by performing control such that the pre-stack process is not executed.

### Example of Step of Inferring Positional Displacement Amount

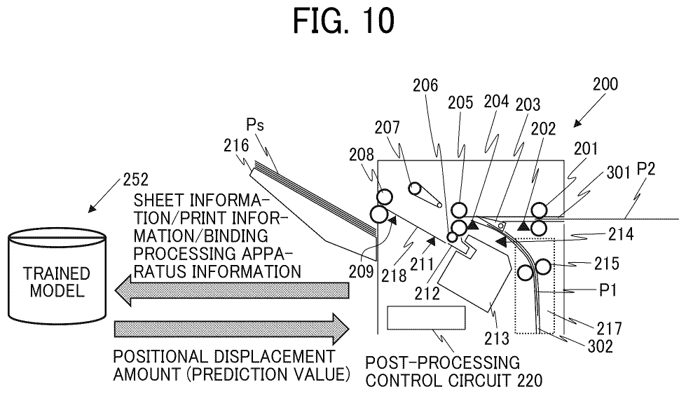

The inference step of estimating the amount of positional displacement from the trained model 252 will be described with reference to FIG. 10.

FIG. 10 is a diagram illustrating an outline of a process in which the amount of positional displacement is inferred by the trained model.

In the present embodiment, when a sheet is actually received and superposed on a pre-stack sheet, the amount of positional displacement is predicted by the trained model 252 generated by machine learning. The medium information and the print information held in the image forming apparatus 100 and the binding process apparatus information held in the post-processing apparatus 200 are input from the post-processing control circuit 220 to the trained model 252. Then, the post-processing control circuit 220 receives, as output data, a prediction value (estimated value) of the amount of positional displacement to be caused when the sheet bundle Ps is stacked on the staple tray 218. The sheet bundle Ps includes a pre-stack sheet (pre-stack sheet P1) and a received sheet (succeeding sheet P2) superposed thereon.

The control program to be executed in the post-processing control circuit 220 determines, from the prediction value of the amount of positional displacement received from the trained model 252, whether the amount of positional displacement falls within the range of a product standard value, whether there is a possibility that a medium may become missing in binding. When it is determined that a failure is caused by positional displacement, control is changed so that the positional displacement does not occur.

For example, the job interval of the stapling operation is increased to change the control in such a way as to perform the stapling operation without performing the pre-stacking control. In this control, the job interval is increased and thus, productivity is lowered. Meanwhile, since it is not to collectively convey multiple sheets superposed by the pre-stacking function, it is possible to avoid occurrence of binding displacement due to positional displacement of the end portions of the multiple sheets.

Furthermore, as long as the pressurizing force of the return roller 206 can be changed, control may be performed such that the conveyance force of the return roller 206 is increased by a change in pressurizing force. As described with reference to FIG. 5B, in a case where the pre-stacking function is used, sheets are stacked and conveyed such that the leading end portion of the succeeding sheet P2 in the conveyance direction slightly precedes the leading end portion of the pre-stack sheet P1 that has been pre-stacked in the conveyance direction. Here, the “conveyance direction” refers to a direction from the inlet roller pair 201 and the pre-stacking conveyance roller pair 215 toward the conveyance roller pair 205.

Here, assume that the amount of displacement of the leading end portions in the conveyance direction between the pre-stack sheet P1 and the succeeding sheet P2 is set to “10.0 mm” in advance. It is possible to reduce the possibility of occurrence of binding displacement due to the positional displacement of trailing ends of the pre-stack sheet P1 and the succeeding sheet P2 in the conveyance direction by controlling the driving of one or both of the inlet roller pair 201 and the pre-stacking conveyance roller pair 215 in such a way as to reduce a leading end displacement amount on the basis of the prediction value of the amount of positional displacement. In addition, if the amount of positional displacement of the trailing ends of the pre-stack sheet P1 and the succeeding sheet P2 in the conveyance direction can be reduced, it is also possible to prevent a medium from missing in binding.

The “trailing ends of the pre-stack sheet P1 and the succeeding sheet P2 in the conveyance direction” refers to the leading end portion of the sheet bundle Ps in the direction in which the sheet bundle Ps is moved on the staple tray 218 toward the contact guide plate 212, as with the “end portions of the multiple stacked sheets” described above.

In a case where the trained model 252 generated by machine learning is used, there is a possibility that optimal control can be performed even for combinations not expected at the time of generating the trained model 252. For example, since coated paper has a structure in which a paper surface is coated with a coating material, coated paper generally has a thickness equal to or greater than medium weight paper. Meanwhile, there is also a possibility that a user obtains thin coated paper and performs printing. Even in such a case, the trained model 252 can predict the amount of positional displacement to be caused in a case where thin coated paper is used. Thus, the control of the post-processing apparatus 200 can be changed in accordance with the prediction value of the amount of positional displacement.

As described above, the post-processing apparatus 200 according to the present embodiment enables the amount of positional displacement to be estimated by an internal process of the post-processing apparatus 200. Therefore, it is possible to prevent a medium from missing in binding without depending on connection with a communication network or the environment of the image forming apparatus 100, for example.

In addition, providing the machine trained model in the estimation unit makes it possible to estimate an appropriate amount of positional displacement even for combinations not evaluated at the time of design.

In addition, when there is a possibility that binding displacement due to positional displacement may be caused by execution of the pre-stack process, it is possible to avoid occurrence of binding displacement due to positional displacement by not performing the pre-stack process even if inter-medium time is extended.

### Control Flow According to First Embodiment

A description will be given of a first embodiment of a control process that can be executed in the post-processing apparatus 200.

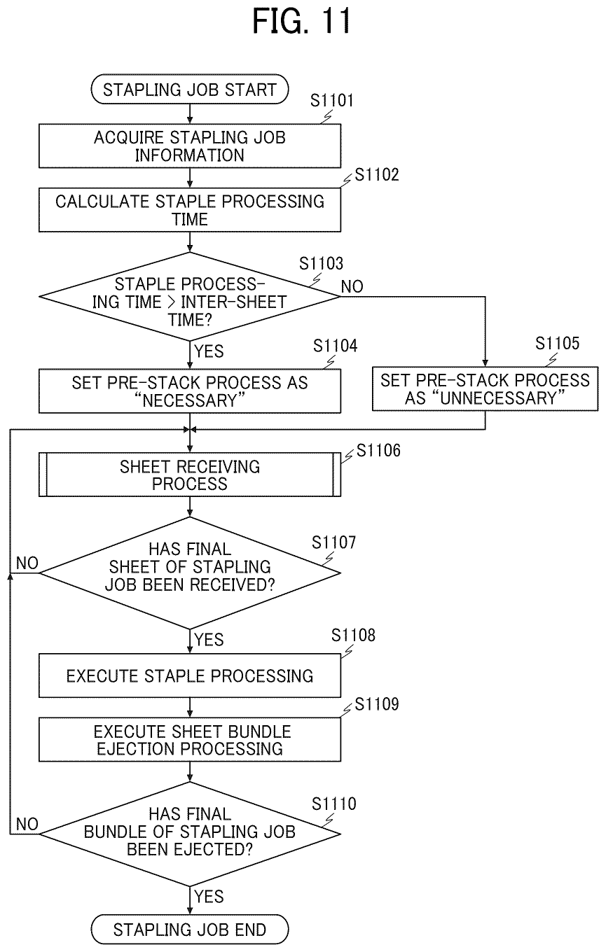

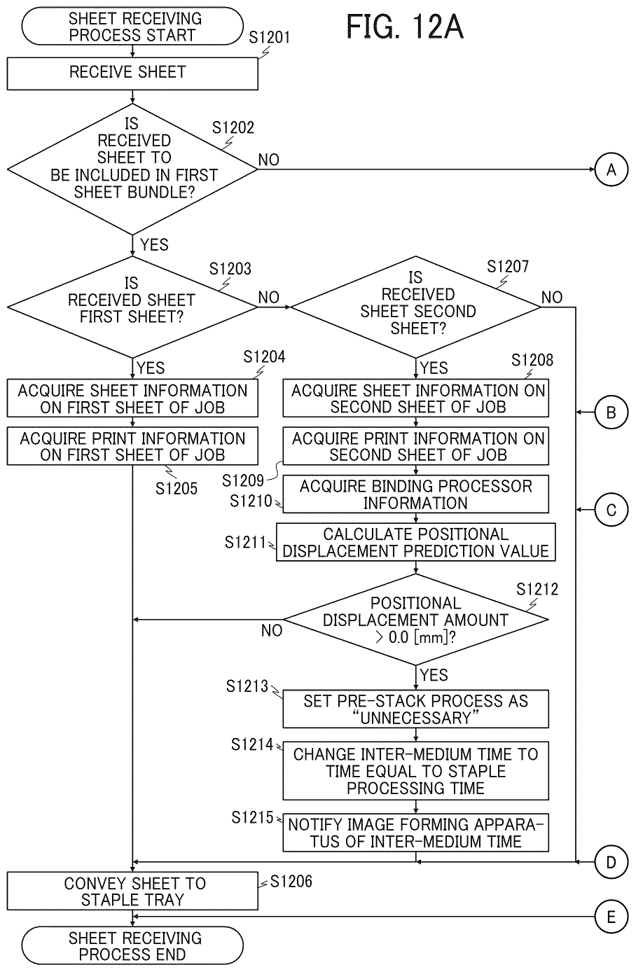

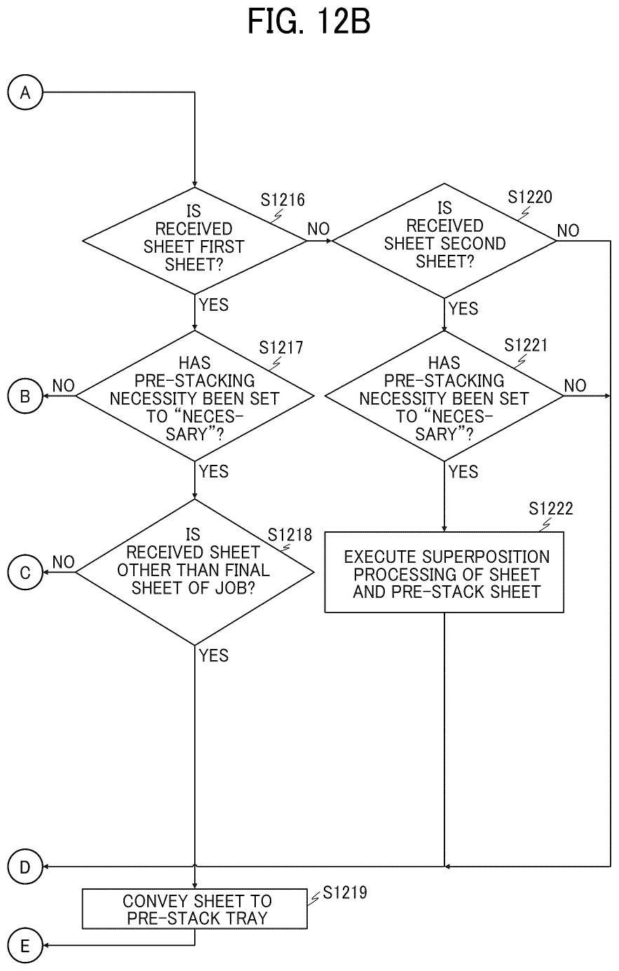

FIGS. 11, and 12A and 12B are flowcharts illustrating flows of a control process according to the first embodiment, in which whether the pre-stack process is to be performed is changed according to a result of estimation by a trained model.

Each embodiment and each example described in the present specification relate to the control process to be implemented by execution of a control program written in the post-processing control circuit 220 of the post-processing apparatus 200. In addition, the control process to be described below is an example of a process to be implemented by a functional block that executes the control program written in the post-processing control circuit 220 on hardware resources of the post-processing control circuit 220 and controls operation of each mechanism.

When a stapling job is started, information on the stapling job (stapling job information) is acquired which includes, for example, stapling position information such as oblique binding and two-position binding, a binding type such as stapled binding and stapleless binding, the number of sheets to be included in a single sheet bundle, and the number of copies of the sheet bundle, which are first notified by the image forming apparatus 100 (step S1101). From the acquired stapling job information, inter-sheet time (referred to as “inter-medium time”) and a staple processing time are calculated (step S1102). The inter-medium time refers to a time interval between multiple conveyed sheets. In other words, the control program to be executed in the post-processing control circuit 220 includes an inter-medium time calculation unit. Here, the “staple processing time” refers to a time from when a first sheet included in the sheet bundle Ps is placed on the staple tray 218 to when the sheet bundle Ps subjected to the binding process is ejected from the staple tray 218. Furthermore, the “inter-medium time” refers to a time from when ejection of the sheet bundle Ps from the staple tray 218 is completed to when a first sheet to be included in a subsequent sheet bundle Ps is conveyed to the staple tray 218.

Then, the inter-medium time of the multiple sheets is compared with the staple processing time (step S1103). When the staple processing time is longer than the inter-medium time of the multiple sheets (YES in step S1103), the pre-stack process is set as “execute pre-stack process” (step S1104). When the staple processing time is shorter than the inter-medium time of the multiple sheets (NO in step S1103), the pre-stack process is set as “not execute pre-stack process” (step S1105).

Subsequently, a sheet receiving process is executed (step S1106). Details of the sheet receiving process will be described with reference to the flowchart of FIGS. 12A and 12B.

FIGS. 12A and 12B are the first and second halves of a flowchart illustrating a control process that can be executed by the post-processing apparatus 200.

After the sheet receiving process is executed, it is determined whether a final sheet of the stapling job has been received (step S1107). In a case where the sheet receiving process has not been executed on the final sheet of the stapling job (NO in step S1107), the process returns to step S1106 to receive the subsequent sheet.

In a case where the sheet receiving process has been executed on the final sheet of the stapling job (YES in step S1107), the stapling operation is executed (step S1108). Subsequently, the ejection process is executed on the sheet bundle Ps subjected to the stapling operation (step S1109). In other words, the control program to be executed in the post-processing control circuit 220 includes a staple control unit.

In a case where the sheet bundle Ps ejected into the sheet ejection tray 216 by the ejection process is not a final bundle of the stapling job (NO in step S1110), the process returns to step S1106 to repeatedly execute the process in steps S1106 to S1110 until a determination of “YES” is made in step S1110. In a case where the sheet bundle Ps ejected into the sheet ejection tray 216 by the ejection process is the final bundle of the stapling job (YES in step S1110), the stapling job is terminated.

### Sheet Receiving Process According to First Embodiment

Details of the sheet receiving process in step S1106 will be described with reference to the flowchart of FIGS. 12A and 12B.

First, the post-processing control circuit 220 executes a process of receiving a sheet (step S1201), and determines whether the received sheet is a sheet to be included in the first sheet bundle Ps (step S1202).

In a case where the received sheet is to be included in the first sheet bundle Ps (YES in step S1202), it is determined whether the sheet received in step S1201 is a first sheet at the timing when the medium information and the image formation setting information are determined in the image forming process of the image forming apparatus 100 (step S1203). In the following description, the “first sheet” corresponds to the pre-stack sheet P1 illustrated in FIG. 4A. In other words, assume a case where the sheet to be processed which has been received in step S1201 corresponds to a sheet that cannot be conveyed to the staple tray 218 and is to be retracted in the pre-stacking portion 217 because the alignment process of the sheet bundle Ps including multiple sheets has already been performed in the staple tray 218. In such a case, the sheet to be processed is regarded as the “first sheet”. In addition, in the following description, a “second sheet” refers to a sheet received subsequently to the pre-stack sheet P1 retracted in the pre-stacking portion 217, as with the succeeding sheet P2 illustrated in FIG. 5A.

In a case where the sheet received in step S1201 is the first sheet (YES in step S1203), medium information and image formation setting information related to the sheet are acquired (steps S1204 and S1205). Subsequently, the sheet received in step S1201 is conveyed to the staple tray 218 (step S1206), and the end portion of the sheet is contacted to the contact guide plate 212 by the return roller. Thus, the sheet receiving process is terminated.

In a case where the sheet received in step S1201 is not the first sheet (NO in step S1203), it is determined whether the sheet received in step S1201 is the second sheet (step S1207). In a case where the sheet received in step S1201 is not the second sheet (NO in step S1207), the sheet received in step S1201 is conveyed to the staple tray 218 (step S1206), and the end portion of the sheet is contacted to the contact guide plate 212 by the return roller. Thus, the sheet receiving process is terminated.

In a case where the sheet received in step S1202 is the second sheet (YES in step S1207), medium information, image formation setting information, and binding processor information related to the sheet are acquired (steps S1208, S1209 and S1210). Subsequently, the acquired information (medium information, image formation setting information, and binding process information) is used for input to the trained model 252, and a prediction value (estimated value) of the amount of positional displacement is calculated (step S1211).

When the calculated prediction value of the amount of positional displacement is equal to or less than a predetermined specified value (NO in step S1212), the sheet received in step S1201 is conveyed to the staple tray 218 (step S1206), and the end portion of the sheet is contacted to the contact guide plate 212 by the return roller. Thus, the sheet receiving process is terminated.

When the prediction value of the amount of positional displacement is greater than the predetermined specified value (YES in step S1212), the setting of whether the pre-stacking process is performed is changed to “not perform pre-stack process” so as to prevent occurrence of binding displacement due to positional displacement (step S1213). In the present embodiment, the “predetermined specified value” is “0.0 mm”.

Subsequently, when the pre-stack process is not executed, the inter-medium time of multiple sheets to be conveyed is insufficient to receive a first sheet of a subsequent stapling job. Thus, the inter-medium time is changed to time equal to the time to complete the stapling operation (step S1214). Then, the changed inter-medium time is notified to the image formation control circuit 101 of the image forming apparatus 100 (step S1215).

In other words, the image forming apparatus 100 is an example of a medium supply device. In addition, the image formation control circuit 101 included in the image forming apparatus 100 includes an inter-medium control unit that controls inter-medium time corresponding to a conveyance interval between multiple sheets according to the notified inter-medium time of the multiple sheets to be conveyed. The conveyance interval for the multiple sheets received from the image forming apparatus 100 by the post-processing apparatus 200 is controlled by the inter-medium control unit.

In a case where the sheet received in step S1201 is not to be included in the first sheet bundle Ps (NO in step S1202) and is the first sheet (YES in step S1216), a tray to which the sheet is to be conveyed differs depending on the setting of whether the pre-stacking process is performed. Thus, the setting of whether the pre-stacking process is performed is determined (step S1217). When whether the pre-stacking is performed has been set to “perform pre-stacking process” (YES in step S1217), it is determined whether the received sheet is a sheet other than the final sheet of the stapling job (step S1218). In a case where the sheet is not the final sheet of the stapling job (YES in step S1218), the sheet is conveyed to the pre-stacking portion 217 (step S1219), and the sheet receiving process is terminated. In other words, the control program to be executed in the post-processing control circuit 220 includes a pre-stacking control unit.

When whether the pre-stacking is performed has been set to “not perform pre-stacking process” (NO in step S1217), the sheet is conveyed to the staple tray 218 (step S1216), and the end portion of the sheet is contacted to the contact guide plate 212 by the return roller. Thus, the sheet receiving process is terminated. In addition, in step S1218, when the sheet is the final sheet of the stapling job (NO in step S1218), the sheet is conveyed to the staple tray 218 (step S1206), and the end portion of the sheet is contacted to the contact guide plate 212 by the return roller. Thus, the sheet receiving process is terminated.

In a case where the sheet received in step S1201 is not to be included in the first sheet bundle Ps (NO in step S1202) and is not the first sheet (NO in step S1216), it is determined whether the sheet received in step S1201 is the second sheet (step S1220). In a case where the sheet received in step S1201 is not the second sheet (NO in step S1220), the sheet received in step S1201 is conveyed to the staple tray 218 (step S1206), and the end portion of the sheet is contacted to the contact guide plate 212 by the return roller. Thus, the sheet receiving process is terminated.

In a case where the sheet received in step S1201 is the second sheet (YES in step S1220), the setting of whether the pre-stacking process is performed is determined (step S1221). When whether the pre-stacking process is performed has been set to “not perform pre-stacking” (NO in step S1221), the sheet is conveyed to the staple tray 218 (step S1206), and the end portion of the sheet is contacted to the contact guide plate 212 by the return roller. Thus, the sheet receiving process is terminated.

When whether the pre-stacking process is to be performed has been set to “perform pre-stacking” (YES in step S1221), a superposition operation of the first sheet (the pre-stack sheet P1 in FIGS. 5A to 5C) already conveyed to the pre-stacking portion 217 and the subsequent second sheet (the succeeding sheet P2 in FIGS. 5A to 5C) to be subsequently conveyed is executed (step S1222). Here, the “superposition operation” refers to operation of causing the first pre-stack sheet P1, which has been press-tacked as described with reference to FIGS. 5A and 5B, to join the second succeeding sheet P2 to be conveyed subsequently to the pre-stack sheet P1, and conveying the sheets joined together to the downstream side by the conveyance roller pair 205.

Thereafter, the stacked first and second sheets are conveyed as they are to the staple tray 218 (step S1206), and the end portions of the sheets are contacted to the contact guide plate 212 by the return roller. Thus, the sheet receiving process is terminated. In addition, since it is not to switch control according to the setting of whether the pre-stacking is to be performed for third and subsequent sheets of second and subsequent bundles, the sheet received in step S1201 may be conveyed to the staple tray 218 as it is.

Assume a case of whether the pre-stacking process is to be performed is set to “not perform pre-stacking” after the stapling job is started (step S1105), in other words, a case where, in the process of receiving the first sheet bundle Ps, the image formation control circuit 101 of the image forming apparatus 100 has been notified that (step S1215) it has been determined that the prediction value of the amount of positional displacement is greater than the predetermined specified value (YES in step S1212), the setting of whether the pre-stacking process is to be performed has been changed to “not perform pre-stacking” (step S1213), and the inter-medium time has been changed to the time equal to the time to complete the stapling operation (step S1214). In such a case, a determination of “No” is made in step S1103 of FIG. 11, and thus, whether the pre-stacking process is to be performed is set to “not perform pre-stacking” in step S1105. Thereafter, in a case where the control flow of the sheet receiving process illustrated in FIGS. 12A and 12B is started, it is determined that the pre-stacking process is not performed (NO in step S1217 and NO in step S1221) for both the first sheet and the second sheet of the second and subsequent bundles (in the case of NO in step S1202), and the process proceeds to step S1206 in both cases. Therefore, the first sheet and the second sheet of the second and subsequent bundles are conveyed to the staple tray 218 as they are (step S1206). As described above, it is possible to perform the stapling operation while changing whether the pre-stack process is performed according to the prediction value of the amount of positional displacement based on the trained model 252.

In other words, according to the post-processing apparatus 200 of the present embodiment, when there is a possibility that binding displacement due to positional displacement may be caused by execution of the pre-stack process, it is possible to avoid occurrence of binding displacement due to positional displacement by not performing the pre-stack process even if inter-medium time is extended. In addition, it is possible to optimize productivity by optimally controlling the inter-medium time depending on the presence or absence of pre-stacking control.

### Control Flow According to Second Embodiment

A description will be given of a second embodiment of a control process that can be executed in the post-processing apparatus 200.

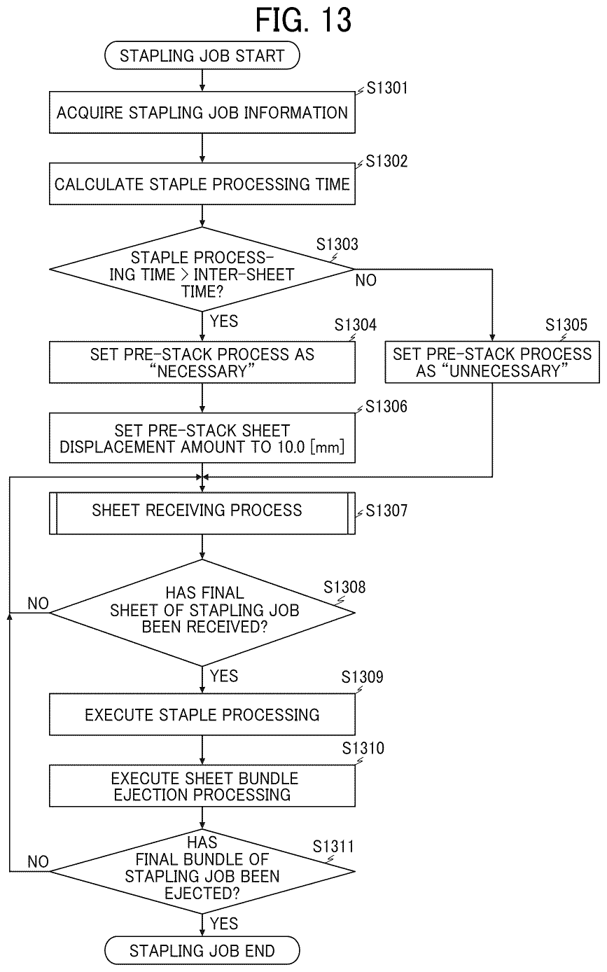

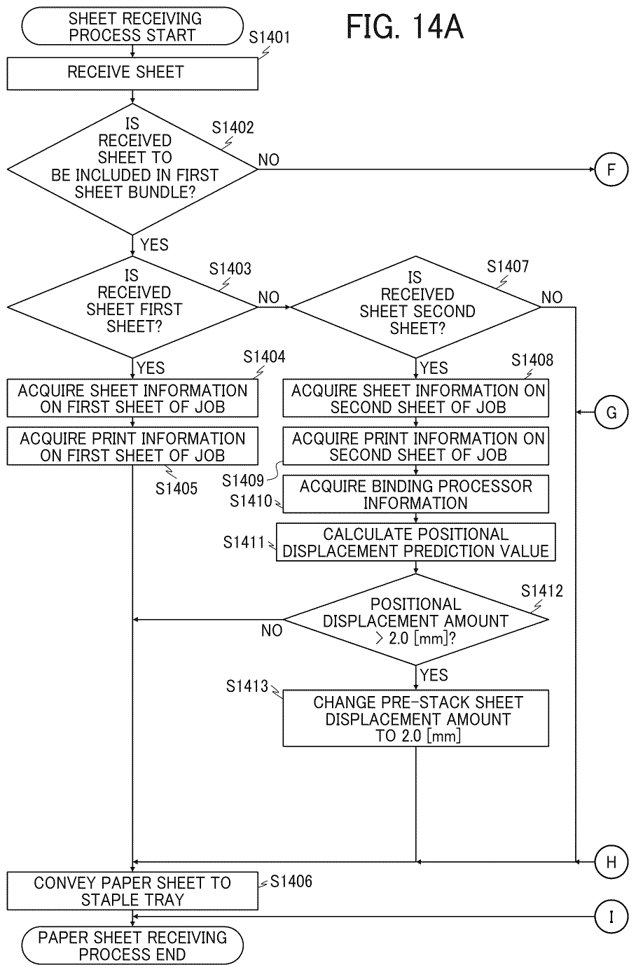

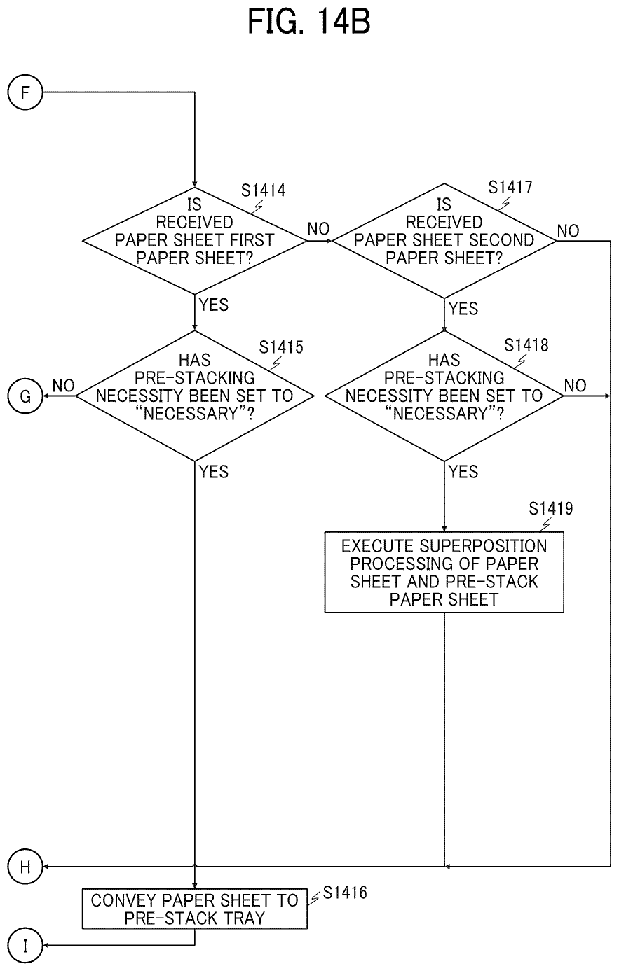

FIGS. 13, and 14A and 14B are flowcharts illustrating flows of the control process according to the second embodiment, in which the amount of displacement to be caused at the time of the superposition operation of multiple sheets is changed according to a result of estimation by the trained model.

FIG. 13 is a flowchart illustrating an exemplary control process that can be executed by the post-processing apparatus 200.

FIGS. 14A and 14B are the first and second halves of a flowchart illustrating an exemplary control process that can be executed by the post-processing apparatus 200.

With regard to a stapling job process illustrated in FIG. 13, a detailed description of a portion overlapping with the stapling job process according to the first embodiment illustrated in FIG. 11 will be simplified, and differences will be described in detail.

After the start of the stapling job (step S1301), the inter-medium time of multiple sheets is compared with the staple processing time (step S1103), and the process of setting whether the pre-stacking process is to be performed to “perform pre-stacking” or “not perform pre-stacking” is performed in the setting of whether to perform the pre-stack process as the superposition operation of the multiple sheets (steps S1304 and S1305), as in steps S1101 to S1105 of the first embodiment.

When whether the pre-stacking process is to be performed is set to “perform pre-stacking” (step S1304), the amount of displacement (the “pre-stack sheet displacement amount”) to be caused at the time of the superposition operation of the first sheet (the pre-stack sheet P1 in FIGS. 5A to 5C) already conveyed to the pre-stacking portion 217 and the subsequent second sheet (the succeeding sheet P2 in FIGS. 5A to 5C) to be subsequently conveyed is set to a default value (step S1306). In the present embodiment, the default value of the pre-stack sheet displacement amount is set to, for example, “10 mm”.

Thereafter, the sheet receiving process is executed (step S1307). Details of the sheet receiving process according to the second embodiment will be described with reference to the flowchart of FIGS. 14A and 14B. Meanwhile, when whether the pre-stacking process is to be performed is set to “not perform pre-stacking” (step S1305), the sheet receiving process is executed as it is (step S1307).

After the sheet receiving process is executed, it is determined whether the final sheet of the stapling job has been received (step S1308), and the final bundle of the stapling job is ejected (YES in step S1311) to complete the stapling job. The process from step S1308 to step S1311 according to the present embodiment is similar to the process from step S1107 to step S1110 according to the first embodiment.

### Sheet Receiving Process According to Second Embodiment

Details of the sheet receiving process in step S1307 will be described with reference to the flowchart of FIGS. 14A and 14B.

First, the post-processing control circuit 220 executes a process of receiving a sheet (step S1401), and determines whether the received sheet is a sheet to be included in the first sheet bundle Ps (step S1402).

In a case where the received sheet is to be included in the first sheet bundle Ps (YES in step S1402), it is determined whether the sheet received in step S1401 is a first sheet at the timing when the medium information and the image formation setting information are determined in the image forming process of the image forming apparatus 100 (step S1403). In a case where the sheet received in step S1401 is the first sheet (YES in step S1403), medium information and image formation setting information related to the sheet are acquired (steps S1404 and S1405). Subsequently, the sheet received in step S1401 is conveyed to the staple tray 218 (step S1406), and the end portion of the sheet is contacted to the contact guide plate 212 by the return roller. Thus, the sheet receiving process is terminated.

In a case where the sheet received in step S1401 is not the first sheet (NO in step S1403), it is determined whether the sheet received in step S1401 is the second sheet (step S1407). In a case where the sheet received in step S1401 is not the second sheet (NO in step S1407), the sheet received in step S1401 is conveyed to the staple tray 218 (step S1406), and the end portion of the sheet is contacted to the contact guide plate 212 by the return roller. Thus, the sheet receiving process is terminated.

Meanwhile, in a case where the sheet received in step S1401 is the second sheet (YES in step S1407), the medium information, the image formation setting information, and the binding processor information related to the sheet are acquired (steps S1408, S1409 and S1410). Subsequently, the acquired information (medium information, image formation setting information, and binding process information) is used for input to the trained model 252, and a prediction value of the amount of positional displacement is calculated (step S1411).

In a case where the calculated prediction value of the amount of positional displacement is equal to or less than “2.0 mm” (NO in step S1412), the sheet received in step S1401 is conveyed to the staple tray 218 (step S1406), and the end portion of the sheet is contacted to the contact guide plate 212 by the return roller. Thus, the sheet receiving process is terminated.

In a case where the calculated prediction value of the amount of positional displacement is greater than “2.0 mm” (YES in step S1412), the amount of displacement (pre-stack sheet displacement amount) to be caused at the time of the superposition operation of multiple sheets is changed to a value (2.0 mm) at which no medium becomes missing in binding (step S1413). The value “2.0 mm” is set in step S1413. Meanwhile, stapling position is often set to a position of about “5.0 mm” from a sheet trailing end. Therefore, it is possible to prevent a medium from missing in binding by changing the pre-stack sheet displacement amount to a value less than the set value.

Thereafter, the sheet received in step S1401 is conveyed to the staple tray 218 (step S1406), and the end portion of the sheet is contacted to the contact guide plate 212 by the return roller. Thus, the sheet receiving process is terminated.

In a case where the sheet received in step S1401 is not to be included in the first sheet bundle Ps, in other words, is to be included in a second or subsequent sheet bundle Ps (NO in step S1402), and is the first sheet (YES in step S1S1414), a tray to which the sheet is to be conveyed differs depending on the setting of whether the pre-stacking process is to be performed. Thus, the setting of whether the pre-stacking process is to be performed is determined (step S1415). When whether the pre-stacking process is to be performed has been set to “perform pre-stacking” (YES in step S1415), the sheet is conveyed to the pre-stacking portion 217 (step S1416), and the sheet receiving process is terminated.

When whether the pre-stacking process is to be performed has been set to “not perform pre-stacking” (NO in step S1415), the sheet is conveyed to the staple tray 218 (step S1406), and the end portion of the sheet is contacted to the contact guide plate 212 by the return roller. Thus, the sheet receiving process is terminated.

In a case where the sheet received in step S1401 is not to be included in the first sheet bundle Ps (NO in step S1402) and is not the first sheet (NO in step S1414), it is determined whether the sheet received in step S1401 is the second sheet (step S1417). In a case where the sheet received in step S1401 is not the second sheet (NO in step S1417), the sheet received in step S1401 is conveyed to the staple tray 218 (step S1406), and the end portion of the sheet is contacted to the contact guide plate 212 by the return roller. Thus, the sheet receiving process is terminated.

In a case where the sheet received in step S1401 is the second sheet (YES in step S1417), the setting of whether the pre-stacking process is to be performed is determined (step S1418). When whether the pre-stacking process is to be performed has been set to “not perform pre-stacking” (NO in step S1418), the sheet is conveyed to the staple tray 218 (step S1406), and the end portion of the sheet is contacted to the contact guide plate 212 by the return roller. Thus, the sheet receiving process is terminated.

When whether the pre-stacking process is to be performed has been set to “perform pre-stacking” (YES in step S1418), the superposition operation of the first sheet already conveyed to the pre-stacking portion 217 and the subsequent second sheet to be subsequently conveyed is executed (step S1419). At that time, the superposition operation of the first sheet and the second sheet is executed based on the pre-stack sheet displacement amount set in step S1413. Thereafter, the stacked first and second sheets are conveyed to the staple tray 218 (step S1416), and the end portions of the sheets are contacted to the contact guide plate 212 by the return roller. Thus, the sheet receiving process is terminated.

According to the post-processing apparatus 200 of the present embodiment described above, when a large positional displacement actually occurs, it may be difficult to completely eliminate binding displacement to be caused by the positional displacement. However, in a case where the amount of positional displacement is sufficiently large to cause a medium to be missing in binding, it is possible to reliably prevent a medium from missing in binding due to the positional displacement by reducing the amount of displacement of leading ends of multiple sheets from about 10 mm to about 2 mm. In addition, it is possible to maintain high productivity of the entire image forming process by effectively utilizing the pre-stack process.

### Medium Processing Apparatus According to Third Embodiment

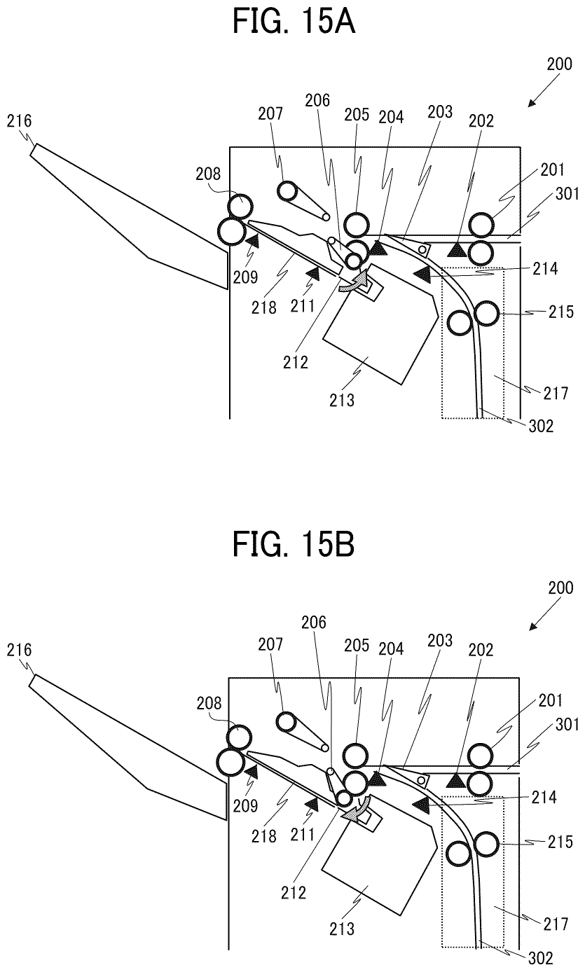

A third embodiment of the medium processing apparatus according to the present disclosure will be described with reference to FIGS. 15A and 15B.

FIGS. 15A and 15B are explanatory diagrams of return roller control that can be executed by the post-processing apparatus 200.

The post-processing apparatus 200 according to the present embodiment includes the return roller 206 that can change pressurizing force to be applied to the sheet bundle Ps.

As illustrated in FIGS. 15A and 15B, the return roller 206 according to the present embodiment is configured such that the return roller 206 can be driven up and down as a return roller pressurizing unit. This configuration implements the function of allowing a pressurizing force (return roller pressurizing force) for pressing the return roller 206 against the sheet bundle Ps to be changed when the sheet bundle Ps is conveyed to the contact guide plate 212. When the return roller pressurizing force is high, the return roller 206 is strongly brought into close contact with the sheet bundle Ps. Therefore, the conveyance force of sheets can be increased.

The post-processing apparatus 200 according to the present embodiment makes it possible to prevent binding displacement due to positional displacement by changing the pressurizing force of the return roller 206 to increase conveyance force for sheets.

### Control Flow According to Third Embodiment

A description will be given of a third embodiment of the control process that can be executed in the post-processing apparatus 200.

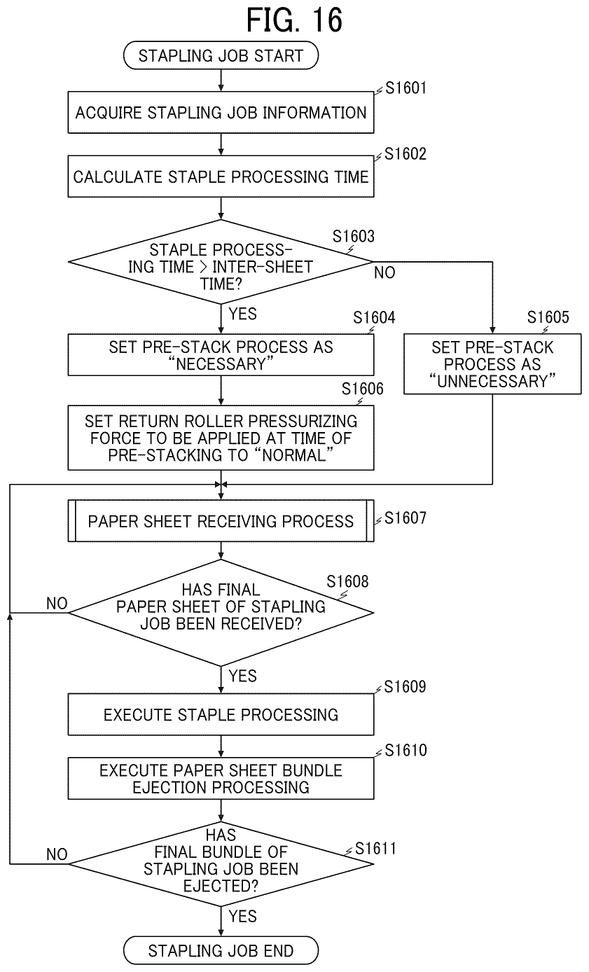

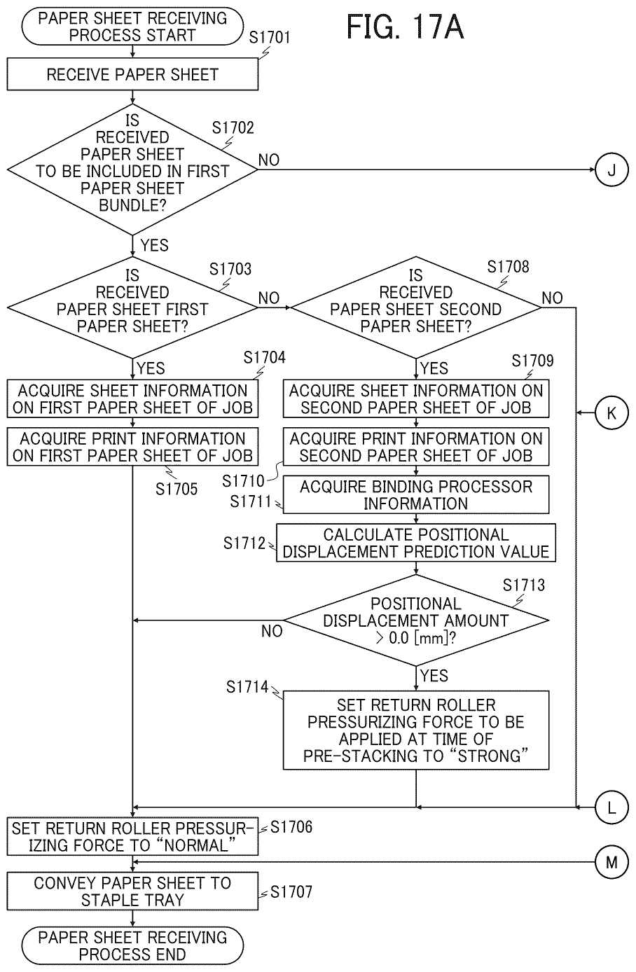

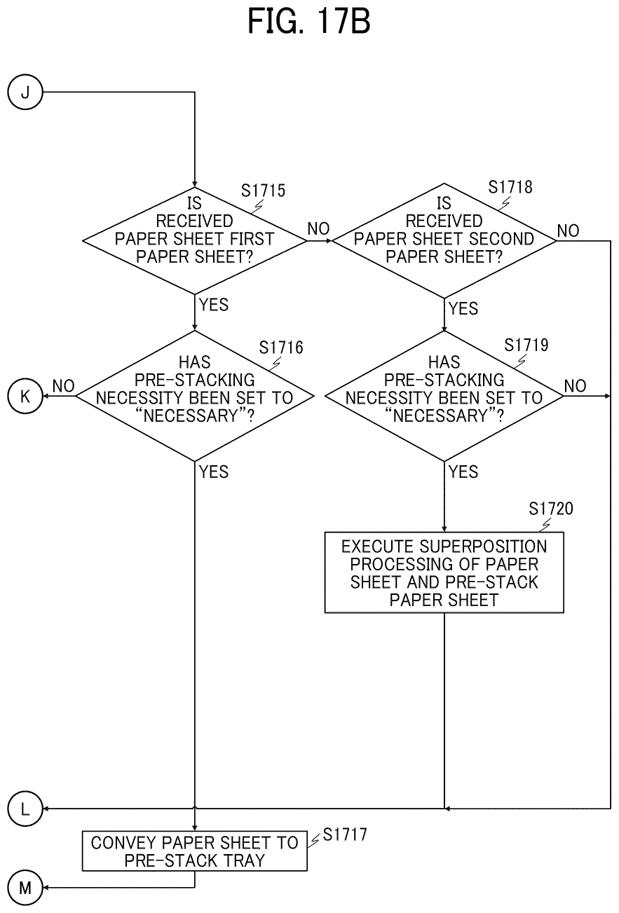

FIGS. 16, and 17A and 17B are flowcharts illustrating flows of the control process according to the third embodiment, in which return roller pressurizing force to be applied when the sheet bundle Ps is conveyed to the contact guide plate 212 is changed according to a result of estimation by the trained model.

With regard to a stapling job process illustrated in FIG. 16, a detailed description of a portion overlapping with the stapling job processes according to the first embodiment and the second embodiment will be simplified, and differences will be described in detail.

After the start of the stapling job (step S1601), the inter-medium time of multiple sheets is compared with the staple processing time (step S1603), and the process of setting whether the pre-stacking process is to be performed to “perform pre-stacking” or “not perform pre-stacking” is performed in the setting of whether to perform the pre-stack process as the superposition operation of the multiple sheets (steps S1604 and S1605), as in steps S1101 to S1105 of the first embodiment.

When whether the pre-stacking process is to be performed is set to “perform pre-stacking” (step S1604), the return roller pressurizing force for the sheet bundle Ps including the first sheet (the pre-stack sheet P1 in FIGS. 5A to 5C) already conveyed to the pre-stacking portion 217 and the subsequent second sheet (the succeeding sheet P2 in FIGS. 5A to 5C) to be subsequently conveyed is set to a default value (step S1606). In the present embodiment, return roller pressurizing force to be applied at the time of pre-stacking is set to “normal”.

As illustrated in FIGS. 6B and 6C, the “return roller pressurizing force to be applied at the time of pre-stacking” refers to the pressurizing force of the return roller to be applied when the pre-stack sheet P1 and the succeeding sheet P2 subjected to the superposition operation are conveyed on the staple tray 218 toward the contact guide plate 212, and the end portion of the pre-stack sheet P1 and the end portion of the succeeding sheet P2 are contacted to the contact guide plate 212 to be aligned.

Thereafter, the sheet receiving process is executed (step S1607). Details of the sheet receiving process according to the third embodiment will be described with reference to the flowchart of FIGS. 17A and 17B.

After the sheet receiving process is executed, it is determined whether the final sheet of the stapling job has been received (step S1608), and the final bundle of the stapling job is ejected (YES in step S1611) to complete the stapling job, as in the process in steps S1107 to S1110 according to the first embodiment.

### Sheet Receiving Process According to Third Embodiment

Details of the sheet receiving process in step S1607 will be described with reference to the flowchart of FIGS. 17A and 17B.

FIGS. 17A and 17B are the first and second halves of a flowchart illustrating a control process that can be executed by the post-processing apparatus 200.

First, the post-processing control circuit 220 executes a process of receiving a sheet (step S1701), and determines whether the received sheet is a sheet to be included in the first sheet bundle Ps (step S1702).

In a case where the received sheet is to be included in the first sheet bundle Ps (YES in step S1702) and is the first sheet (YES in step S1S1703), medium information and image formation setting information related to the sheet are acquired (steps S1704 and S1705), return roller pressurizing force is set to “normal” (step S1706), and the sheet is conveyed to the staple tray 218 (step S1707). Thus, the sheet receiving process is terminated.

In a case where the sheet received in step S1701 is the second sheet (YES in step S1708), the medium information, the image formation setting information, and the binding processor information related to the sheet are acquired (steps S1709, S1710 and S1711). Subsequently, the acquired information (medium information, image formation setting information, and binding process information) is used for input to the trained model 252, and a prediction value of the amount of positional displacement is calculated (step S1712). Meanwhile, in a case where the sheet received in step S1701 is not the second sheet (NO in step S1708), the return roller pressurizing force is set to “normal” (step S1706), the sheet is conveyed to the staple tray 218 (step S1707), and the end portion of the sheet is contacted to the contact guide plate 212 by the return roller. Thus, the sheet receiving process is terminated.

Then, in a case where the prediction value of the amount of positional displacement is less than “0.0 mm” (NO in step S1713), the return roller pressurizing force is set to “normal” (step S1706), the second sheet is conveyed to the staple tray 218 (step S1707), and the end portion of the second sheet is contacted to the contact guide plate 212 by the return roller. Thus, the sheet receiving process is terminated.

Meanwhile, when the prediction value of the amount of positional displacement is greater than “0.0 mm” (YES in step S1713), the return roller pressurizing force to be applied at the time of pre-stacking is set to “strong” (step S1714) so as to change the return roller pressurizing force to be applied at the time of conveying the sheet bundle Ps, in which the pre-stack sheet P1 and the succeeding sheet P2 are stacked. Thus, occurrence of binding displacement due to positional displacement can be prevented. Then, the second sheet is conveyed to the staple tray 218 (step S1707), and the end portion of the second sheet is contacted to the contact guide plate 212 by the return roller. Thus, the sheet receiving process is terminated.

In a case where the sheet received in step S1701 is not to be included in the first sheet bundle Ps (NO in S1702) and is the first sheet (YES in step S1715), the setting of whether the pre-stacking process is to be performed is determined (step S1716). When whether the pre-stacking process is to be performed is set to “perform pre-stacking” (YES in step S1716), the sheet is conveyed to the pre-stacking portion 217 (step S1717), and the sheet receiving process is terminated.

When whether the pre-stacking process is to be performed has been set to “not perform pre-stacking” (NO in step S1716), return roller pressurizing force is set to “normal” (step S1706) to convey the first sheet to the staple tray 218 (step S1707), and the end portion of the first sheet is contacted to the contact guide plate 212 by the return roller. Thus, the sheet receiving process is terminated.

In a case where the sheet received in step S1701 is not to be included in the first sheet bundle Ps (NO in step S1702) and is not the first sheet (NO in step S1715), it is determined whether the sheet received in step S1701 is the second sheet (step S1718). In a case where the sheet received in step S1701 is not the second sheet (NO in step S1718), the return roller pressurizing force is set to “normal” (step S1706), the sheet is conveyed to the staple tray 218 (step S1707), and the end portion of the sheet is contacted to the contact guide plate 212 by the return roller. Thus, the sheet receiving process is terminated.

In a case where the sheet received in step S1701 is the second sheet (YES in step S1718), the setting of whether the pre-stacking process is to be performed is determined (step S1719). When whether the pre-stacking process is to be performed has been set to “not perform pre-stacking” (NO in step S1719), the return roller pressurizing force is set to “normal” (step S1706) to convey the second sheet to the staple tray 218 (step S1707), and the end portion of the second sheet is contacted to the contact guide plate 212 by the return roller. Thus, the sheet receiving process is terminated.

When whether the pre-stacking process is to be performed has been set to “perform pre-stacking” (YES in step S1719), the superposition operation of the first sheet conveyed to the pre-stacking portion 217 and the second sheet is executed to form a sheet bundle Ps (step S1720). Subsequently, the return roller pressurizing force is set to the return roller pressurizing force to be applied at the time of pre-stacking, set in step S1714 (step S1721). In other words, the return roller pressurizing force (“strong”) to be applied at the time of pre-stacking, which has been changed in step S1714, is reflected in the return roller pressurizing force before the sheet bundle Ps is conveyed to the staple tray 218. Thus, the return roller pressurizing force is changed from “normal” to “strong”. Thereafter, the sheet bundle Ps is conveyed to the staple tray 218 (step S1707), and the end portion of the second sheet is contacted to the contact guide plate 212 by the return roller. Thus, the sheet receiving process is terminated. As a result, it is possible to reduce occurrence of binding displacement due to positional displacement by contacting the sheet bundle Ps against the contact guide plate 212 in a state where the conveyance force of the return roller 206 is increased.

When a large positional displacement actually occurs, it is difficult to completely eliminate the positional displacement. However, since the pre-stack process is effective, the post-processing apparatus 200 according to the third embodiment makes it possible to perform control while keeping the productivity of the entire print process at a high level. In other words, it is possible to prevent occurrence of binding displacement due to positional displacement by changing the pressurizing force of the return roller 206 to increase conveyance force.

### Control Flow According to Fourth Embodiment

A description will be given of a fourth embodiment of a control process that can be executed in the post-processing apparatus 200.

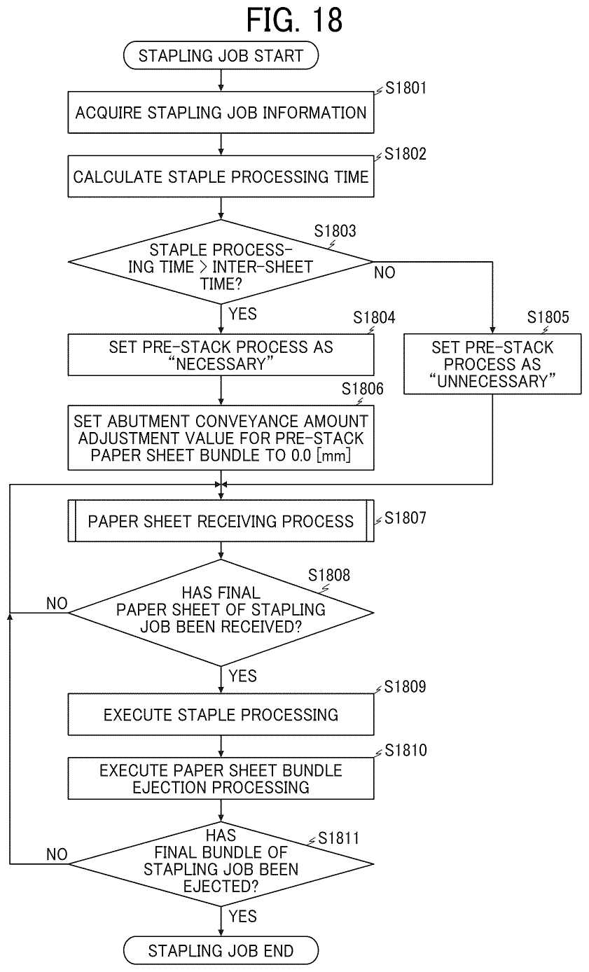

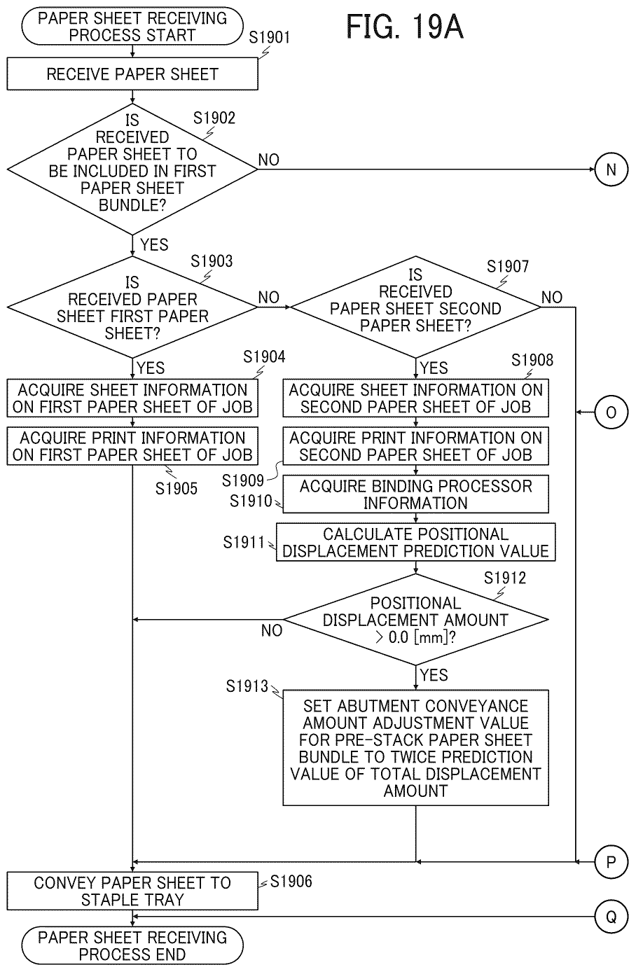

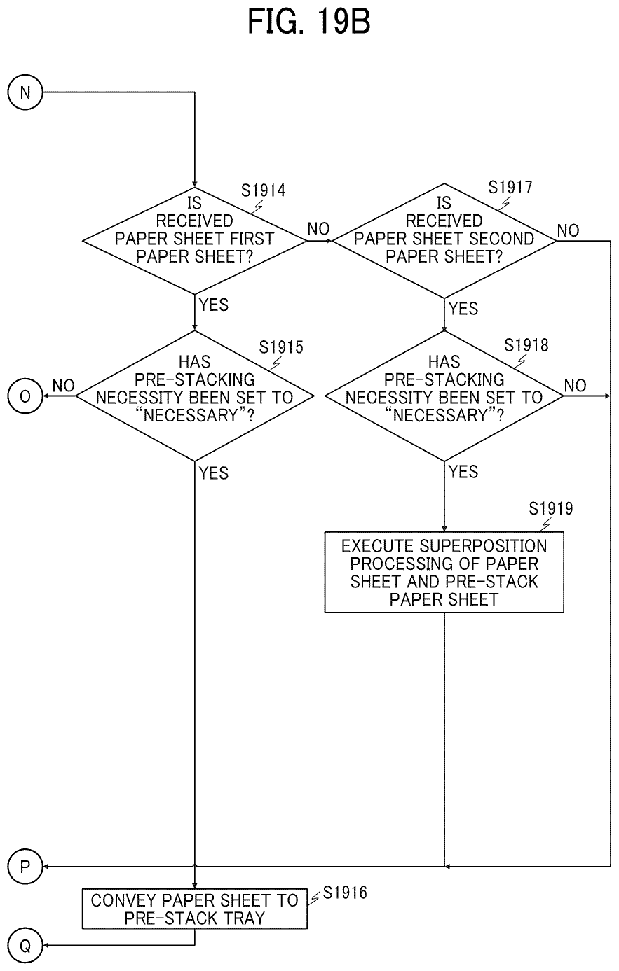

FIGS. 18, and 19A and 19B are flowcharts illustrating flows of the control process according to the fourth embodiment, in which the amount of conveyance to be performed when the sheet bundle Ps is contacted to the contact guide plate 212 is changed according to a result of estimation by the trained model.

With regard to a stapling job process illustrated in FIG. 18, a detailed description of a portion overlapping with the stapling job processes according to the second embodiment and the fourth embodiment will be simplified, and differences will be described in detail.

After the start of the stapling job (step S1801), the inter-medium time of multiple sheets is compared with the staple processing time (step S1803), and the process of setting whether the pre-stacking process is to be performed to “perform pre-stacking” or “not perform pre-stacking” is performed in the setting of whether to perform the pre-stack process as the superposition operation of the multiple sheets (steps S1804 and S1805), as in steps S1101 to S1105 of the first embodiment.

When whether the pre-stacking process is to be performed is set to “perform pre-stacking” (step S1804), an adjustment value (“contact amount adjustment value”) for the amount of contact to be caused when the sheet bundle Ps including the first sheet (the pre-stack sheet P1 in FIGS. 5A to 5C) already conveyed to the pre-stacking portion 217 and the subsequent second sheet (the succeeding sheet P2 in FIGS. 5A to 5C) to be subsequently conveyed is contacted to the contact guide plate 212 is set to a default value (step S1806). In the present embodiment, a default value of the contact amount adjustment value is set to, for example, “0.0 mm”.

Thereafter, the sheet receiving process is executed (step S1807). Details of the sheet receiving process according to the fourth embodiment will be described with reference to the flowchart of FIGS. 19A and 19B. Meanwhile, when whether the pre-stacking process is to be performed is set to “not perform pre-stacking” (step S1805), the sheet receiving process is executed as it is (step S1807).

After the sheet receiving process is executed, it is determined whether the final sheet of the stapling job has been received (step S1808), and the final bundle of the stapling job is ejected (YES in step S1811) to complete the stapling job. The process from step S1808 to step S1811 according to the present embodiment is similar to the process from step S1107 to step S1110 according to the first embodiment.

### Sheet Receiving Process According to Fourth Embodiment

Details of the sheet receiving process in step S1807 will be described with reference to the flowchart of FIGS. 19A and 19B.

FIGS. 19A and 19B are the first and second halves of a flowchart illustrating a control process that can be executed by the post-processing apparatus 200.

First, the post-processing control circuit 220 executes a process of receiving a sheet (step S1901), and determines whether the received sheet is a sheet to be included in the first sheet bundle Ps (step S1902).

In a case where the received sheet is to be included in the first sheet bundle Ps (YES in step S1902), it is determined whether the sheet received in step S1901 is a first sheet at the timing when the medium information and the image formation setting information are determined in the image forming process of the image forming apparatus 100 (step S1903). In a case where the sheet received in step S1901 is the first sheet (YES in step S1903), the medium information and the image formation setting information related to the sheet are acquired (steps S1904 and S1905). Subsequently, the sheet received in step S1201 is conveyed to the staple tray 218 (step S1906), and the end portion of the sheet is contacted to the contact guide plate 212 by the return roller. Thus, the sheet receiving process is terminated.

In a case where the sheet received in step S1901 is not the first sheet (NO in step S1903), it is determined whether the sheet received in step S1901 is the second sheet (step S1907). In a case where the sheet received in step S1901 is not the second sheet (NO in step S1907), the sheet received in step S1901 is conveyed to the staple tray 218 (step S1906), and the end portion of the sheet is contacted to the contact guide plate 212 by the return roller. Thus, the sheet receiving process is terminated.

Meanwhile, in a case where the sheet received in step S1901 is the second sheet (YES in step S1907), the medium information, the image formation setting information, and the binding processor information related to the sheet are acquired (steps S1908, S1909 and S1910). Subsequently, the acquired information (medium information, image formation setting information, and binding process information) is used for input to the trained model 252, and a prediction value of the amount of positional displacement is calculated (step S1911).

In a case where the calculated prediction value of the amount of positional displacement is equal to or less than “0.0 mm” (NO in step S1912), the sheet received in step S1901 is conveyed to the staple tray 218 (step S1906), and the end portion of the sheet is contacted to the contact guide plate 212 by the return roller. Thus, the sheet receiving process is terminated.

In a case where the calculated prediction value of the amount of positional displacement is greater than “0.0 mm” (YES in step S1912), the contact amount adjustment value is changed to twice the estimated value of the amount of positional displacement (step S1913). The contact amount adjustment value set in step S1913 may be a predetermined value (fixed value). Subsequently, the sheet received in step S1901 is conveyed to the staple tray 218 (step S1906), and the end portion of the sheet is contacted to the contact guide plate 212 by the return roller. Thus, the sheet receiving process is terminated.

In a case where the sheet received in step S1901 is not to be included in the first sheet bundle Ps, in other words, is to be included in the second or subsequent sheet bundle Ps (NO in step S1902), and is the first sheet (YES in step S1914), a tray to which the sheet is to be conveyed differs depending on the setting of whether the pre-stacking process is to be performed. Thus, the setting of whether the pre-stacking process is to be performed is determined (step S1915). When whether the pre-stacking process is to be performed has been set to “perform pre-stacking” (YES in step S1915), the sheet is conveyed to the pre-stacking portion 217 (step S1916), and the sheet receiving process is terminated.

When whether the pre-stacking process is to be performed has been set to “not perform pre-stacking” (NO in step S1915), the sheet is conveyed to the staple tray 218 (step S1906), and the end portion of the sheet is contacted to the contact guide plate 212 by the return roller. Thus, the sheet receiving process is terminated.

In a case where the sheet received in step S1901 is not to be included in the first sheet bundle Ps (NO in step S1902) and is not the first sheet (NO in step S1914), it is determined whether the sheet received in step S1901 is the second sheet (step S1917). In a case where the sheet received in step S1901 is not the second sheet (NO in step S1917), the sheet received in step S1901 is conveyed to the staple tray 218 (step S1906), and the end portion of the sheet is contacted to the contact guide plate 212 by the return roller. Thus, the sheet receiving process is terminated.

In a case where the sheet received in step S1901 is the second sheet (YES in step S1917), the setting of whether the pre-stacking process is to be performed is determined (step S1918). When whether the pre-stacking process is to be performed has been set to “not perform pre-stacking” (NO in step S1918), the sheet is conveyed to the staple tray 218 (step S1906), and the end portion of the sheet is contacted to the contact guide plate 212 by the return roller. Thus, the sheet receiving process is terminated.

When whether the pre-stacking process is to be performed has been set to “perform pre-stacking” (YES in step S1918), the superposition operation of the first sheet already conveyed to the pre-stacking portion 217 and the subsequent second sheet to be subsequently conveyed is executed (step S1919). Thereafter, the stacked first and second sheets are conveyed to the staple tray 218 (step S1906), and the end portions of the sheets are contacted to the contact guide plate 212 by the return roller based on the contact amount adjustment value set in step S1913. Thus, the sheet receiving process is terminated.

The post-processing apparatus 200 according to the fourth embodiment prevents binding displacement due to positional displacement by increasing the amount of conveyance to the contact guide plate 212.

### First Example of Acquisition of Medium Information and Print Information

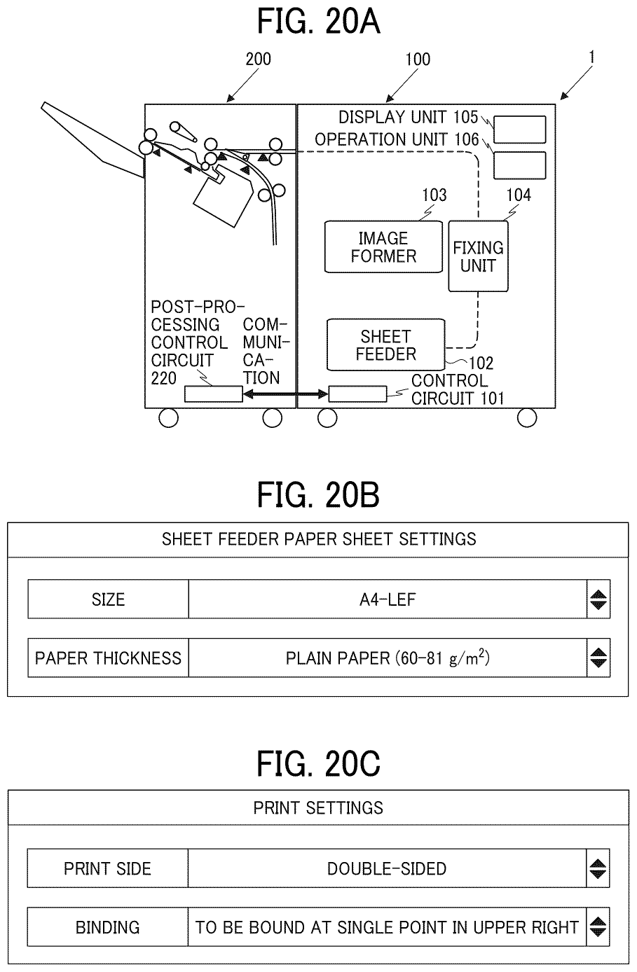

A first example of a method for acquiring medium information and print information common to the first to fourth embodiments will be described with reference to FIGS. 20A, 20B and 20C.

FIGS. 20A, 20B and 20C are diagrams illustrating a method for acquiring medium information and image forming information that can be executed in the image forming system 1.

As with FIG. 1, FIG. 20A is a system configuration diagram illustrating a system configuration in which the post-processing apparatus 200 is coupled to the image forming apparatus 100.

The image forming apparatus 100 includes a sheet feeder 102, an image former 103, a fixing unit 104, and a conveyance function. The sheet feeder 102 feeds a printing sheet. The image former 103 forms an image to be transferred to the printing sheet. The fixing unit 104 transfers the image formed by the image former 103 to the printing sheet. The conveyance function is for conveying, to the post-processing apparatus 200, the printing sheet to which the image has been transferred by the fixing unit 104. In order to set print process in the image forming apparatus 100, the image forming apparatus 100 includes a display unit 105 and an operation unit 106.

The display unit 105 and the operation unit 106 may be integrated into a touch panel that can be operated by a user.

In a case where the user sets the print process by using the display unit 105 and the operation unit 106, the size, thickness, for example, of the printing sheet are set as illustrated in FIG. 20B. The information (medium information) to be set here is held in the image formation control circuit 101 of the image forming apparatus 100. Communication data are sent to the post-processing control circuit 220 of the post-processing apparatus 200. Thus, the post-processing apparatus 200 can acquire the medium information.

As illustrated in FIG. 20C, the user can also configure print settings. Print information (image formation setting information) based on the print settings is also sent as communication data serving as a control signal to the post-processing control circuit 220 of the post-processing apparatus 200. As a result, the post-processing apparatus 200 can acquire the print information.

As described above, according to the image forming system 1 which is an embodiment of the image forming system according to the present disclosure, the user sets the medium information and the print information by the display unit 105 and the operation unit 106 included in the medium information input unit. This eliminates the need for sensors to be used for acquiring the medium information and the print information. As a result, the image forming system 1 can be developed at lower cost.

### Second Example of Acquisition of Medium Information

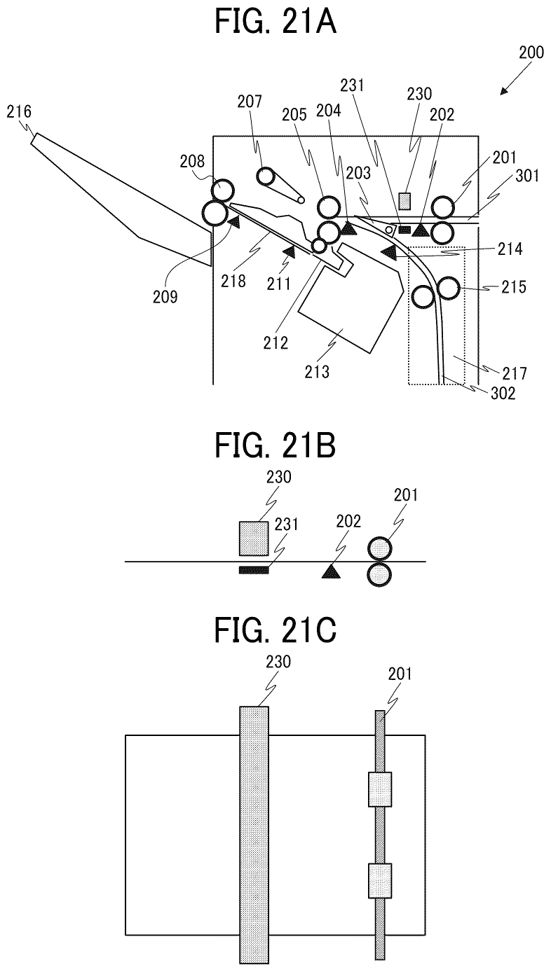

Here, a second example of a medium information acquisition method common to the first to fourth embodiments will be described with reference to FIG. 21.

FIG. 21 illustrates an exemplary case of acquiring medium information related to a conveyed sheet by installing a contact image sensor (CIS) 230 and a background plate 231 between a sheet receiving portion of the post-processing apparatus 200 and a branch portion of the pre-stacking portion 217.

The CIS 230 includes image sensors that acquire images and are arranged in the main scanning direction. The CIS 230 is a sensor that can recognize a passing sheet as a single image by acquiring consecutive images. The background plate 231 is installed at a portion facing the CIS 230.

For example, assuming that a sheet passing through the CIS 230 is white and the background plate 231 is black, the CIS 230 can recognize the end portion of the sheet in the main scanning direction (width direction) based on a difference in color tone. Then, sheet length (sheet width) in the main scanning direction can be acquired from the distance between end portions of sheets in the main scanning direction.

In addition, the state of an inlet sensor 202 changes depending on the leading end and the trailing end of a sheet. The sheet length in the sub-scanning direction (sheet conveyance direction) can be acquired from time changing depending on the leading end and the trailing end and the conveyance linear speed of the sheet at which the sheet passes through the inlet sensor 202, in other words, the drive speed of an inlet roller pair 201. Furthermore, it is possible to acquire paper thickness information which is a piece of medium information by providing a paper thickness detector as a mechanism that acquires the thickness of a sheet by acquiring the amount of change in a gap between a pair of rollers to be caused when the sheet passes through a nip of the inlet roller pair 201.

As described above, according to the post-processing apparatus 200 serving as the medium processing apparatus according to the embodiment of the present disclosure, it is possible to estimate a more accurate amount of positional displacement by acquiring various types of medium information based on sensing by the CIS 230 and the inlet sensor 202 included in the medium information detector.

### First Example of Selection of Binding Displacement Prevention Control

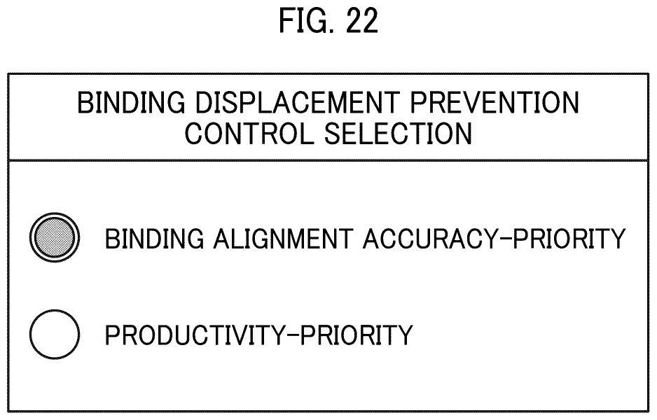

A first example of binding displacement prevention control common to the first to fourth embodiments will be described with reference to FIG. 22.

FIG. 22 is a diagram illustrating a method for specifying a control process that can be executed by the post-processing apparatus 200.

As is already clear from the description of the control process according to the first to fourth embodiments, there are advantages and disadvantages depending on a control method to be selected even when occurrence of the pre-stacking binding displacement is predicted and control is performed based on the prediction value.

In the first embodiment, it is possible to avoid binding displacement itself by not performing pre-stacking control. However, there is a possibility that productivity may decrease due to an increase in inter-medium time.

In the second embodiment and the third embodiment, since the pre-stacking control is performed, productivity does not decrease, but there is a possibility that binding displacement itself cannot be eliminated. Therefore, there is a possibility that the quality of a binding process may decrease.

Therefore, in order to allow a user to freely select the type of control mode to be specified when binding displacement occurs, operation is performed such that a binding displacement prevention control selection screen serving as a binding displacement prevention control specifying unit illustrated in FIG. 22 is displayed on the display unit 105 to receive a selection input via the operation unit 106.

For example, in a case where a user generates a sheet bundle Ps which is a document to be distributed to the outside, it is to give priority to maintaining the quality of the binding process. Therefore, “binding alignment accuracy” is selected to be prioritized, and the binding process is performed by the control for switching between the execution and non-execution of the pre-stack process described in the first embodiment.

Meanwhile, in a case where the sheet bundle Ps to be used as an internal document is generated, it is to prioritize productivity. Therefore, the binding process is performed by the control for reducing the amount of displacement to be caused when the pre-stack sheet according to the second embodiment and a succeeding sheet are stacked. Providing the control switching function as described above allows usage according to user's application purposes.

According to the examples described above, it is possible to customize control, such as “productivity-priority” and “binding quality-priority”, to be performed at the time of occurrence of binding displacement according to the desire of the user.

### Example of Mode of Holding Trained Model

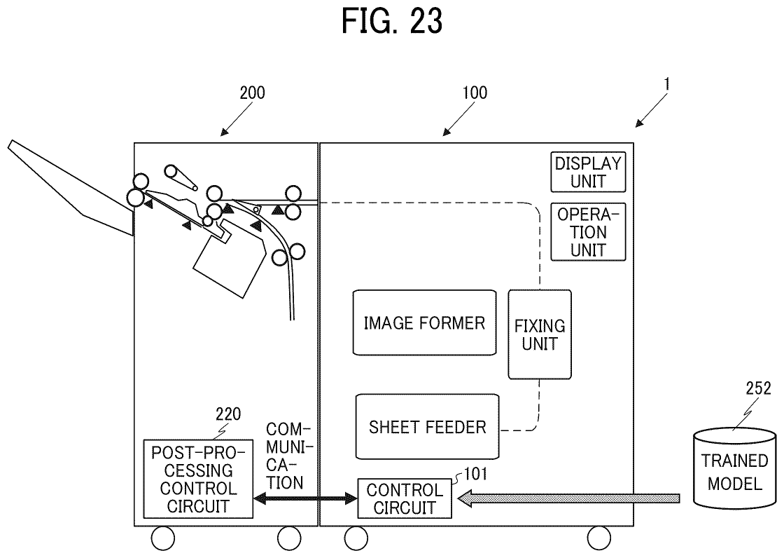

An example of a mode of holding the trained model 252 in the image forming system 1 according to the present embodiment will be described with reference to FIG. 23.

FIG. 23 is a diagram illustrating an exemplary case of installing the trained model on the image forming system 1.

The trained model 252 described above is written as a part of the control program into the post-processing control circuit 220 of the post-processing apparatus 200 (see FIG. 8).

Since the trained model 252 is a part of the control program, the trained model 252 may be held in a device other than the post-processing apparatus 200. For example, as illustrated in FIG. 23, the trained model 252 may be held as a part of a control program to be written in the image formation control circuit 101 of the image forming apparatus 100 with which the post-processing apparatus 200 communicates. In general, since the image forming apparatus 100 has a function of setting medium information and print information, it is possible to estimate the amount of positional displacement based on the information.

As described above, even if the post-processing apparatuses 200 according to the first to fourth embodiments do not have the trained model 252, the trained model 252 can also be held as a part of a control program included in the image formation control circuit 101 of the image forming apparatus 100 coupled to the post-processing apparatus 200. In other words, the trained model 252 can be located in a device external to the post-processing apparatus 200.

### Another Example of Mode of Holding Trained Model

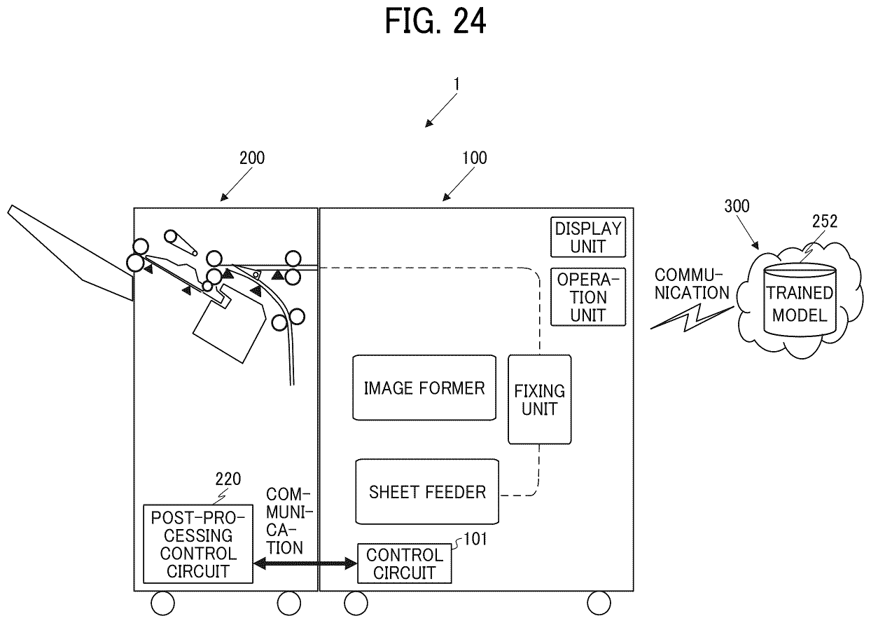

Another example of a mode of holding the trained model 252 in the image forming system 1 according to the present embodiment will be described with reference to FIG. 24.

FIG. 24 is a diagram illustrating another exemplary case of installing the trained model on the image forming system 1.

Since the trained model 252 is a part of a control program, the trained model 252 may be held in a device other than the post-processing apparatus 200. For example, as illustrated in FIG. 24, the trained model 252 may be held on a cloud system 300 with which the image forming apparatus 100 or the post-processing apparatus 200 communicates.

In this case, the medium information and the print information for estimating the amount of positional displacement are transmitted to the cloud system 300, and the image forming apparatus 100 or the post-processing apparatus 200 receives again a result of estimation made on the cloud system 300. Thus, the amount of positional displacement can be estimated. In addition, the trained model 252 may be usually held and placed on the cloud system, and the trained model 252 on the cloud system 300 may be downloaded for use at the timing when the image forming apparatus 100 or the post-processing apparatus 200 is turned on. This method eliminates the need for communication between the image forming apparatus 100 and the cloud system 300 at the timing of printing or alignment process. It is thus possible to shorten the time from the user's instruction for printing to the start of printing.

As described above, even if the post-processing apparatuses 200 according to the first to fourth embodiments do not have the trained model 252, the trained model 252 can be held in the cloud system 300 coupled to the image forming system 1 in a manner that allows notification.

As described above, according to the embodiments of the medium processing apparatus, the image forming apparatus, and the image forming system of the present disclosure, it is possible to estimate the possibility that sheets stick at the time of the pre-stack process by a trained model, and change control of the stapling operation including pre-stacking according to an estimation result, in the post-processing apparatus 200. Adoption of this configuration makes it possible to avoid sheet sticking in the pre-stack tray, and makes it possible to prevent binding displacement and prevent a medium from missing in binding at the time of the stapling operation.

The present disclosure is not limited to specific embodiments described above, and numerous additional modifications and variations are possible in light of the teachings within the technical scope of the appended claims. The above-described embodiments represent examples, and various modifications can be achieved by those skilled in the art from the disclosed contents. Such modifications and variations are included in the technical scope described in the appended claims.

### Aspects of the Present Disclosure

### Aspects of the Present Disclosure Are, for Example, As Follows.

### Aspect 1

In Aspect 1, a medium processing apparatus is for performing a predetermined process on a sheet-like medium, the medium processing apparatus including a medium stacker, an end portion processing unit, a positional displacement, and a control unit. The medium stacker allows stacking of multiple media. The end portion processing unit executes a predetermined process related to end portions of media stacked on the medium stacker. The positional displacement amount estimation unit estimates an amount of positional displacement between end portions of multiple media stacked on the medium stacker, based on at least attribute information on the media and image formation setting information to be used for the image forming process on the media. The control unit controls operation of the medium stacker and the end portion processing unit. In reducing operation for reducing the amount of positional displacement according to combinations of the attribute information on the media and the image formation setting information to be used for the image forming process on the media, the control unit controls operation of at least one of the medium stacker or the end portion processing unit based on an estimated value of the amount of positional displacement.

### Aspect 2

In Aspect 2, in the medium processing apparatus according to Aspect 1, the positional displacement amount estimation unit includes at least a trained model generated by a machine learning process using training data including combinations of the attribute information on the media and the image formation setting information to be used for the image forming process on the media.

### Aspect 3

In Aspect 3, in the medium processing apparatus according to Aspect 1 or 2, the medium stacker includes a staple tray, a first conveyor, and a second conveyor. The staple tray is for alignment of the end portions of the media. The first conveyor conveys the media toward the staple tray. The second conveyor allows the media to be conveyed to a pre-stacking conveyance path that branches off partway through conveyance to the staple tray and temporarily retracts the media. The control unit includes a pre-stacking control unit that controls the first conveyor and the second conveyor to superpose a medium to be subsequently conveyed on a medium retracted in the pre-stacking conveyance path.

### Aspect 4

In Aspect 4, in the medium processing apparatus according to Aspect 3, the pre-stacking control unit changes necessity of execution of a superposition operation of the multiple media according to the amount of positional displacement.

### Aspect 5

In Aspect 5, the medium processing apparatus according to Aspect 4 further includes a communication unit coupled to a medium supply device. The communication unit is to transmit and receive a control signal to and from the medium supply device. The medium supply device includes a conveyor and an inter-medium control unit. The conveyor conveys the media to the first conveyor. The inter-medium control unit controls inter-medium time when the multiple media is conveyed by the conveyor. The control unit includes an inter-medium time calculation unit, and a notification unit. The inter-medium time calculation unit calculates the inter-medium time according to necessity of execution of a superposition operation of the multiple media by the pre-stacking control unit. The notification unit notifies, via the communication unit, the medium supply device of the inter-medium time calculated by the inter-medium time calculation unit.

### Aspect 6

In Aspect 6, in the medium processing apparatus according to any one of Aspects 3 to 5, the control unit changes an amount of displacement of the multiple stacked media in a superposition operation of the multiple media according to the amount of positional displacement estimated by the positional displacement amount estimation unit, the superposition operation being performed by the pre-stacking control unit.

### Aspect 7

According to Aspect 7, in the medium processing apparatus according to any one of Aspects 3 to 6, the end portion processing unit includes a contact guide plate, a return roller, and a stapling unit. The contact guide plate contacts trailing ends of the media in the staple tray for alignment of the end portions of the media. The return roller conveys the media to the contact guide plate. The stapling unit performs a stapling operation on a bundle of media stacked on the staple tray. The control unit includes a staple control unit that controls the return roller and the stapling unit to perform the stapling operation on the bundle of media.

### Aspect 8

In Aspect 8, the medium processing apparatus according to Aspect 7 further includes a return roller pressurizing unit that allows pressurizing force to be changed, the pressurizing force being a force for pressing the return roller against the staple tray. The staple control unit allows the pressurizing force to be changed by the return roller pressurizing unit. The control unit changes control of the return roller pressurizing unit by the staple control unit according to the estimated value of the amount of positional displacement.

### Aspect 9

In Aspect 9, in the medium processing apparatus according to Aspect 7 or 8, the control unit changes control of conveying the multiple media to the contact guide plate according to the estimated value of the amount of positional displacement, the multiple media being stacked by the pre-stacking control unit.

### Aspect 10

In Aspect 10, the medium processing apparatus according to any one of Aspects 1 to 9 further includes a medium information input unit that inputs the attribute information on the media. The control unit controls the reducing operation based on the attribute information on the media input by the medium information input unit.

### Aspect 11

In Aspect 11, the medium processing apparatus according to any one of Aspects 1 to 9 further includes a medium information detector that detects the attribute information on the media. The control unit controls the reducing operation based on the attribute information on the media. The attribute information is detected by the medium information detector.

### Aspect 12

In Aspect 12, the medium processing apparatus according to any one of Aspects 1 to 11 further includes a binding displacement prevention control specifying unit that specifies a control mode in a case where positional displacement of the end portions of the media occurs with respect to the estimated value of the amount of positional displacement.

### Aspect 13

In Aspect 13, in the medium processing apparatus according to any one of Aspects 2 to 12, the trained model to be used in the positional displacement amount estimation unit is generated in an external device.

### Aspect 14

In Aspect 14, in the medium processing apparatus according to any one of Aspects 2to 13, the medium processing apparatus is communicably coupled to an external device that holds the trained model. The positional displacement amount estimation unit estimates the amount of positional displacement of the end portions based on the trained model held by the external device.

### Aspect 15

In Aspect 15, an image forming system includes an image forming apparatus that forms an image on a medium, and the medium processing apparatus according to any one of Aspects 1 to 14.

### Aspect 16

In Aspect 16, a medium processing apparatus includes a medium stacker, an end portion processor, and circuitry. The medium stacker stacks media including a medium on which an image is formed by an image forming process. The end portion processor processes end portions of the media stacked on the medium stacker. The circuitry is to estimate a displacement amount of positional displacement between the end portions of the media stacked on the medium stacker, based on at least of attribute information of the media or print information to set the image forming process, and control at least one of the medium stacker or the end portion processor to reduce the displacement amount according to combinations of the attribute information and the print information, based on the displacement amount estimated.

### Aspect 17

In Aspect 17, in the medium processing apparatus according to Aspect 16, the circuitry is further to generate a trained model by a machine learning based on training data including combinations of the attribute information and the print information.

### Aspect 18

In Aspect 18, in the medium processing apparatus according to Aspect 16 or 17, the circuitry is further to generate the trained model in an external device communicably connected to the medium processing apparatus.

### Aspect 19

In Aspect 19, in the medium processing apparatus according to Aspect 18, the circuitry is further to estimate the displacement amount by the trained model generated in the external device.

### Aspect 20

In Aspect 20, in the medium processing apparatus according to Aspect 19, the medium stacker includes a staple tray, a first conveyor, and a second conveyor. The staple tray aligns the end portions of the media. The first conveyor conveys a first medium of the media from a first path toward the staple tray. The second conveyor conveys a second medium of the media to a second path branched from the first path, the second medium passed through the first path, to temporarily retract the second medium from the first path to the second path. The circuitry is further to control the first conveyor and the second conveyor to superpose the first medium on the second medium on the staple tray.

### Aspect 21

In Aspect 21, in the medium processing apparatus according to any one of Aspects 18 to 20, the circuitry is further to determine whether to perform a superposition operation on the media according to the displacement amount.

### Aspect 22

In Aspect 22, the medium processing apparatus according to any one of Aspects 18 to 21 further includes a medium conveyor, and a communication unit. The medium conveyor conveys the medium to the first conveyor. The communication unit is coupled to an image forming apparatus including image forming circuitry configured to control an inter-medium time when the media is conveyed by the medium conveyor. The communication unit transmits and receive a control signal to and from the medium conveyor. The circuitry is to calculate the inter-medium time according to whether the superposition operation of the media is to be performed. The communication unit outputs a notification, via the communication unit, the medium conveyor of the inter-medium time calculated by the circuitry.

### Aspect 23

In Aspect 23, in the medium processing apparatus according to Aspect 22, the circuitry is further to change the displacement amount of the media on the medium stacker, in a superposition operation of the media, according to the displacement amount of the positional displacement estimated.

### Aspect 24

In Aspect 24, in the medium processing apparatus according to Aspect 22 or 23, the end portion processor includes a contact guide plate, a return roller, and a stapler. The contact guide plate contacts trailing ends of the media in the staple tray to align the trailing ends of the media. The return roller conveys the media to the contact guide plate. The stapler performs a stapling operation on the media stacked on the staple tray. The circuitry is further to control the return roller and the stapler to perform the stapling operation on the media.

### Aspect 25

In Aspect 25, the medium processing apparatus according to any one of Aspects 16 to 24 further includes a pressurizing unit to change a pressurizing force applied to the media by the return roller against the staple tray. The circuitry is further to cause the pressurizing unit to change the pressurizing force of the return roller, and change the pressurizing force of the return roller, according to an estimated value of the displacement amount of the positional displacement.

### Aspect 26

In Aspect 26, in the medium processing apparatus according to any one of Aspects 16to 24, the circuitry is further to change a conveyance of the media, stacked on the staple tray, conveyed to the contact guide plate, according to an estimated value of the displacement amount of the positional displacement.

### Aspect 27

In Aspect 27, the medium processing apparatus according to any one of Aspects 16 to 26 further includes an input unit to receive an input of the attribute information on the media. The circuitry is further to reduce the displacement amount based on the attribute information input through the input unit.

### Aspect 28

In Aspect 28, the medium processing apparatus according to any one of Aspects 17 to 27 further includes a medium information detector to detect the attribute information on the media. The circuitry is further to reduce the displacement amount based on the attribute information detected by the medium information detector.

### Aspect 29

In Aspect 29, the medium processing apparatus according to any one of Aspects 17 to 28 further includes a display to display a specifying screen to specify a control mode. The positional displacement of the end portions of the media occurs with respect to an estimated value of the displacement amount of the positional displacement.

### Aspect 30

In Aspect 30, an image forming system includes an image forming apparatus that forms an image on a medium, and the medium processing apparatus according to any one of Aspects 16 to 29.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a medium stacker to stack media including a medium on which an image is formed by an image forming process;
an end portion processor to process end portions of the media stacked on the medium stacker; and
circuitry configured to:
estimate a displacement amount of positional displacement between the end portions of the media stacked on the medium stacker, based on at least of:
attribute information of the media; or
print information to set the image forming process; and
control at least one of the medium stacker or the end portion processor to reduce the displacement amount according to combinations of:
the attribute information; and
the print information,
based on the displacement amount estimated.

2. The medium processing apparatus according to claim 1,
wherein the circuitry is further configured to:
generate a trained model by a machine learning based on training data including combinations of:
the attribute information; and
the print information.

3. The medium processing apparatus according to claim 2,
wherein the circuitry is further configured to generate the trained model in an external device communicably connected to the medium processing apparatus.

4. The medium processing apparatus according to claim 3,
wherein the circuitry is further configured to estimate the displacement amount by the trained model generated in the external device.

5. The medium processing apparatus according to claim 1,
wherein the medium stacker includes:
a staple tray to align the end portions of the media;
a first conveyor to convey a first medium of the media from a first path toward the staple tray; and
a second conveyor to convey a second medium of the media to a second path branched from the first path, the second medium passed through the first path,
to temporarily retract the second medium from the first path to the second path, and
the circuitry is further configured to control the first conveyor and the second conveyor to superpose the first medium on the second medium on the staple tray.

6. The medium processing apparatus according to claim 5,
wherein the circuitry is further configured to determine whether to perform a superposition operation on the media according to the displacement amount.

7. The medium processing apparatus according to claim 6, further comprising:
a medium conveyor to convey the medium to the first conveyor; and
a communication unit coupled to an image forming apparatus including image forming circuitry configured to control an inter-medium time when the media is conveyed by the medium conveyor,
the communication unit to transmit and receive a control signal to and from the medium conveyor,
wherein the circuitry is configured to calculate the inter-medium time according to whether the superposition operation of the media is to be performed, and
the communication unit outputs a notification, via the communication unit, the medium conveyor of the inter-medium time calculated by the circuitry.

8. The medium processing apparatus according to claim 5,
wherein the circuitry is further configured to:
change the displacement amount of the media on the medium stacker, in a superposition operation of the media, according to the displacement amount of the positional displacement estimated.

9. The medium processing apparatus according to claim 5,
wherein the end portion processor includes:
a contact guide plate to contact trailing ends of the media in the staple tray to align the trailing ends of the media;
a return roller to convey the media to the contact guide plate; and
a stapler to perform a stapling operation on the media stacked on the staple tray, and
the circuitry is further configured to control the return roller and the stapler to perform the stapling operation on the media.

10. The medium processing apparatus according to claim 9, further comprising:
a pressurizing unit to change a pressurizing force applied to the media by the return roller against the staple tray,
wherein the circuitry is further configured to:
cause the pressurizing unit to change the pressurizing force of the return roller; and
change the pressurizing force of the return roller,
according to an estimated value of the displacement amount of the positional displacement.

11. The medium processing apparatus according to claim 9,
wherein the circuitry is further configured to:
change a conveyance of the media, stacked on the staple tray, conveyed to the contact guide plate,
according to an estimated value of the displacement amount of the positional displacement.

12. The medium processing apparatus according to claim 1, further comprising:
an input unit to receive an input of the attribute information on the media,
wherein the circuitry is further configured to reduce the displacement amount based on the attribute information input through the input unit.

13. The medium processing apparatus according to claim 1, further comprising:
a medium information detector to detect the attribute information on the media,
wherein the circuitry is further configured to reduce the displacement amount based on the attribute information detected by the medium information detector.

14. The medium processing apparatus according to claim 1, further comprising:
a display to display a specifying screen to specify a control mode,
when the positional displacement of the end portions of the media occurs with respect to an estimated value of the displacement amount of the positional displacement.

15. An image forming system comprising:
an image forming apparatus to form an image on a medium; and
the medium processing apparatus according to claim 1.
